(19) United States
(12) Patent Application Publication
(10) Pub. No.: US 2023/0035513 A1
(43) Pub. Date: Feb. 2, 2023

(54) Fluid Treatment Systems And Methods

(71) Applicants: Jeffery P. Weber, Mathis, TX (US); Alan H. Brown, Mathis, TX (US)

(72) Inventors: Jeffery P. Weber, Mathis, TX (US); Alan H. Brown, Mathis, TX (US)

(21) Appl. No.: 17/877,445

(22) Filed: Jul. 29, 2022

Related U.S. Application Data
(60) Provisional application No. 63/227,772, filed on Jul. 30, 2021.

(51) Int. Cl. B01D 21/24; B01D 21/28; B01D 21/00; B01D 19/00; B01F 25/312; C02F 9/00; E21B 43/34

(52) U.S. Cl. CPC B01D 21/2461; B01D 21/283; B01D 21/0042; B01D 19/00; B01D 21/009; B01F 25/31243; C02F 9/00; E21B 43/35; B01F 2101/305

(57) ABSTRACT

A system for separating solids from a fluid mixture includes a vessel including a first chamber to receive a solid-laden fluid mixture, and a second chamber to receive liquids separated from the solid-laden fluid mixture. In certain aspects, at least one eductor is disposed in the first chamber to flow the solid-laden fluid mixture out of the first chamber. In certain aspects, an auger is disposed in the first chamber to move at least solids of the solid-laden fluid mixture out of the first chamber.

### CONTINUITY DATA

This application is a non-provisional application that claims priority to U.S. Provisional Application No. 63/227,772, filed on Jul. 30, 2021. The disclosure of the prior application is hereby incorporated by reference herein in its entirety.

### FIELD

The present disclosure relates generally to techniques for collecting and handling fluid mixtures, and more particularly to systems and methods for separating solids from fluid mixtures.

The present disclosure also relates to systems and methods for treating fluids, including a variety of well fluids. In other some embodiments, such systems and methods may treat produced water from a well, fluids associated with or resulting from drill out operations, salt water, brines from a well, wastewater, fluid with drill cuttings and/or debris, fluids associated with or resulting from well cementing operations, fluids associated with or resulting from well washout operations, fluids associated with or resulting from well cleanout operations, fluids with oily sand, or fluid flowback from a formation that is being or has been subjected to fracturing.

In some aspects, the present disclosure also relates to systems and methods which facilitate the separation of water, hydrocarbons (such as, but not limited to, oil and liquid hydrocarbons), gas (not limited to any particular gas coming from a well) and solids from streams, fluids, slurries, or mixtures containing them. Some embodiments of the present disclosure relate to systems and methods for fracturing an earth formation; and, in certain particular aspects, to such systems and methods that include a flowback treatment system. In some aspects, the present disclosure also relates to systems and methods for treating salt water, including: salt saline solution; brine; oilfield brines; oil brines; gas brines; oil salt water; gas salt water; produced water with salt and/or brine therein; and water containing salts in solution, such as sodium, calcium, magnesium, or bromides. In further aspects, the present disclosure also relates to systems and methods for treating oily sand and water containing an emulsion of hydrocarbon and byproducts resulting from such treatment; and water heated to specific temperatures to promote the separation of emulsions with solids. In still further aspects, the present disclosure also relates to systems and methods that employ an auger or augers, including shafted or shaft-less augers, augers with a flow channel therethrough and nozzles or exit openings at outer surfaces thereof for applying water under pressure outside the augers.

### BACKGROUND

In the oilfield industry, the completion of subsurface wells to produce hydrocarbons entails the insertion of casing tubulars into a wellbore traversing the subsurface formations. Specialized tools are then inserted into the casing to perforate the walls of the tubular at desired subsurface locations in order to allow the hydrocarbons in the surrounding formation to flow into the casing for collection at the surface. Once the casing is perforated, a well stimulation technique known as hydraulic fracturing is applied to create cracks in the rock formations surrounding the wellbore to create fissures or fractures through which natural gas, hydrocarbons, and other fluids can flow more freely. In this process, a fluid is injected into the casing at high pressure to penetrate the formation via the perforations in the casing. The injected fracturing fluids mix with groundwater, gas, oil, and other materials. When the pressure is removed, part of the fluid mixture can flow back to the surface. This fluid mixture, which is commonly referred to as “flowback,” “flowback water,” or a “flowback stream,” can include water, oil, grease, metals, sealants, salts, gas, gaseous emissions, proppants, debris, rock, solids, and other materials. Fracturing of a particular stage along the casing requires isolation of casing sections. In this way, the hydraulic fracture is created at the location of the perforations. In such operations, a “plug” is set in the casing to seal off the casing section to receive the high-pressure fluid. Once the fracture is initiated, a propping agent, such as sand, is added to the fluid injected into the wellbore.

After all the stages along the casing have been fractured, the series of plugs are removed so that the well can be produced via the perforations from all the stages. It is common during this drill out process to utilize a coil tubing unit or work over rig to remove the plugs placed in the well during the fracturing process. As oil and gas begin to flow into the wellbore, unwanted fluids and gasses, as well as unwanted particulates from the strata (including, sand, salts, etc.), combine with the plug debris forming a fluid mixture in the wellbore. The fluid mixture is brought to the surface through a hydraulic process and the fluid is separated into hydrocarbon and water streams and the water is recirculated as part of the drill out process. Simple frac tanks are commonly used to collect the unwanted flowback from the wellbore. When the frac tank is full of collected fluids, sand, salts, gasses, etc., different techniques are used to process its contents. The collection, removal, and decontamination of the flowback is an expensive process. In some cases, environmentally approved services are employed to remove the flowback collected in the tank.

### SUMMARY

A need exists for improved techniques for separating and reclaiming flowback arriving at the surface from a wellbore. The present disclosure meets these needs.

In at least some of the embodiments, the present disclosure provides systems and methods (which include “processes”) for treating fluid streams and for removing gas, liquids, hydrocarbons, and/or solids from the fluid streams. Some of such systems and methods may use one or more eductors to mix, move, and/or transfer fluid from and/or through a container, tank, vessel, reservoir, pipe, line, chamber, or conduit; and/or to employ eductive force or eductive action or pressure to separate components of a fluid, to cleanse solids of contaminants, and/or to “break” materials from solids. Any eductor in any system or method herein may have a motive fluid flowing to and through it continuously; or an eductor can be used with appropriate controls and associated connections and piping so that it is used non-continuously, e.g., so that eductive action is provided in pulses or periodically.

The present disclosure provides, in at least some aspects, treatment of fluid streams which are aqueous streams or nonaqueous streams. In certain, but not necessarily all embodiments, the present disclosure provides systems and methods (which includes “processes”) for fracturing a formation. In certain, but not necessarily all embodiments, the present disclosure provides systems and methods (which includes “processes”) for treating flowback and for removing gas, liquids, hydrocarbons, and/or solids from the flowback. Certain, but not all, such systems and methods use one or more eductors to mix, move, and/or transfer flowback or one or more components thereof. In certain, but not necessarily all embodiments, the present disclosure provides systems and methods (which includes “processes”) with an auger or augers for moving material; and, in certain particular aspects and features, augers for such systems. In certain, but not necessarily all embodiments, the present disclosure provides systems and methods (which includes “processes”) with an eductor or eductors (with or without an auger or augers) for moving material and/or for cleaning material, e.g., but not limited to, for separating oil from solids in flowback.

Accordingly, the present disclosure includes features and advantages which are believed to advance, inter alia, the arts and technologies of: formation fracturing; fluid treatment; well fluid treatment; water treatment; auger design; well fluid separation; salt water treatment; oily sand treatment; flowback fluid treatment and separation; drill out fluid treatment; and the treatment of fluids with drill cuttings.

Characteristics and advantages of the present disclosure are described above and additional features, non-limiting exemplary embodiments, and benefits are disclosed in the following detailed description of the embodiments and in the accompanying drawings.

Certain embodiments of this disclosure are not limited to any particular individual feature disclosed here, but may include combinations of them distinguished from what is already known in their structures, functions, designs, and/or results achieved. There are, of course, additional aspects of the disclosure described above and below and which may be included in the subject matter of the claims to this disclosure. The claims at the end of this disclosure are to be read to include any legally equivalent parts, elements, devices, combinations, processes, steps, or methods which do not depart from the spirit and scope of the present disclosure.

According to an aspect of the present disclosure, a system for separating solids from a fluid mixture includes a vessel including a first chamber to receive a solid-laden fluid mixture, and a second chamber to receive liquids separated from the solid-laden fluid mixture; at least one eductor disposed in the first chamber to flow the solid-laden fluid mixture out of the first chamber; and an auger disposed in the first chamber to move at least solids of the solid-laden fluid mixture out of the first chamber.

According to an aspect of the present disclosure, a system for separating solids from a fluid mixture includes a vessel including a first chamber to receive a solid-laden fluid mixture, and a second chamber to receive liquids separated from the solid-laden fluid mixture; and an auger disposed in the first chamber to move at least solids of the solid-laden fluid mixture out of the first chamber, wherein the auger is disposed adjacent an inner surface of the vessel, the inner surface comprises an undulated profile including valleys and ridges, and the auger does not contact the valleys of the undulated profile.

According to another aspect of the present disclosure, a method for separating solids from a fluid mixture includes admitting a solid-laden fluid mixture into a first chamber of a vessel; receiving at a second chamber liquids separated from the solid-laden fluid mixture; flowing the solid-laden fluid mixture out of the first chamber via at least one educator provided in the first chamber; and moving at least solids of the solid-laden fluid mixture out of the first chamber via an auger provided in the first chamber.

The following description of certain embodiments is given for the purpose of disclosure, when taken in conjunction with the accompanying drawings. The detail in these descriptions is not intended to thwart this patent's object to claim this invention to the full legal extent possible, no matter how others may later try to disguise it by superficial variations in form, additions, or insubstantial changes in an effort to avoid this patent's claims.

### BRIEF DESCRIPTION OF THE DRAWINGS

The following drawing figures form part of the present specification and are included to further demonstrate certain aspects of the present disclosure. The figures illustrate some, but not all, aspects, features, and embodiments, and are not to be used to improperly limit the scope of the disclosure which may have other equally effective, legally equivalent embodiments. The present claimed subject matter may be better understood by reference to one or more of these drawing figures in combination with the description of embodiments presented herein. Consequently, a more complete understanding of the present embodiments and further features and advantages thereof may be acquired by referring to the following description taken in conjunction with the accompanying drawings, in which like reference numerals may identify like elements, wherein:

FIG. 1 is schematic view of a well system with a flowback treatment system, according to one embodiment.

FIG. 2 is a schematic view of a flowback treatment system according to an embodiment.

FIG. 3 is a schematic view of a system for processing flowback fluid according to an embodiment.

FIGS. 4A and 4B illustrate process flow diagrams of systems for treating water, e.g., contaminated wastewater or flowback, according to an embodiment.

FIG. 5A depicts a schematic of a system configured to separate a fluid mixture in accordance with embodiments of the disclosure.

FIG. 5B is a partial cross section view of the system according to one embodiment.

FIG. 5C is another partial cross section view of the system according to an embodiment.

FIG. 5D depicts a schematic of another system configured to separate a fluid mixture in accordance with embodiments of the disclosure.

FIG. 5E is a further partial cross section view of the system according to an embodiment.

FIG. 6 depicts a perspective view of another embodiment of a system 10 according to an embodiment.

FIG. 7A is a perspective view of another system according to an embodiment.

FIG. 7B is a schematic cross section view of part of the system of FIG. 7A according to an embodiment.

FIG. 7C is an end cross section view of a tank of the system of FIG. 7A according to an embodiment.

FIG. 8 is a schematic view of a fracturing system according to an embodiment.

FIG. 9A is a top view of a bottom of a tank of a system according to an embodiment.

FIG. 9B is a cross-section view along line 9B-9B of FIG. 9A.

FIG. 9C is another top view of a bottom of a tank of a system according to an embodiment.

FIG. 10A is a perspective view of an auger according to an embodiment.

FIG. 10B is a cross-section view of the auger of FIG. 10A according to an embodiment.

FIG. 11 is a side view of an auger according to an embodiment.

FIG. 12A is a side view of an auger in a tank (shown partially) according to an embodiment.

FIG. 12B is a side view of an auger in a tank (shown partially) according to another embodiment.

FIGS. 13A-13D are schematic end cross-section views of part of a system according to some embodiments.

FIG. 14 is a schematic view of a system according to an embodiment.

### DETAILED DESCRIPTION

The foregoing description of the figures is provided for the convenience of the reader. It should be understood, however, that the embodiments are not limited to the precise arrangements and configurations shown in the figures. Also, the figures are not necessarily drawn to scale, and certain features may be shown exaggerated in scale or in generalized or schematic form, in the interest of clarity and conciseness.

While various embodiments are described herein, it should be appreciated that the present disclosure encompasses many inventive concepts that may be embodied in a wide variety of contexts. The following detailed description of exemplary embodiments, read in conjunction with the accompanying drawings, is merely illustrative and is not to be taken as limiting the scope of the disclosure, as it would be impossible or impractical to include all of the possible embodiments and contexts in this disclosure. Upon reading this disclosure, many alternative embodiments will be apparent to persons of ordinary skill in the art. The scope of the disclosure is defined by the appended claims and equivalents thereof.

Illustrative embodiments of the disclosure are described below. In the interest of clarity, not all features of an actual implementation are described in this specification. In the development of any such actual embodiment, numerous implementation-specific decisions may need to be made to achieve the design-specific goals, which may vary from one implementation to another. It will be appreciated that such a development effort, while possibly complex and time-consuming, would nevertheless be a routine undertaking for persons of ordinary skill in the art having the benefit of this disclosure.

Certain, but not all, embodiments of the present disclosure are shown in the above-identified figures and described in detail below. Any combination of aspects and/or features described below can be used except where such aspects and/or features are mutually exclusive. So long as they are not mutually exclusive or contradictory, any aspect, element, step, or feature or combination of aspects, etc., of any embodiment disclosed herein may be used in any other embodiment disclosed herein. For example, if an embodiment with features, elements, steps, or aspects A, R, C, and D is disclosed, and an embodiment with features, elements, steps, and/or aspects A, B, D is possible, then the embodiment with A, B, D is part of this disclosure as an embodiment of the present disclosure; and so forth for all possible combinations of features, elements, steps, and/or aspects.

It should be understood that the drawings figures and description herein are of certain embodiments and are not intended to limit the present disclosure. All modifications, additions, embodiments, equivalents and alternatives falling within the spirit and scope of the disclosure as defined by the appended claims. In showing and describing these embodiments, like or identical reference numerals are used to identify common or similar elements.

The terms “invention”, “present invention”, “disclosure”, “present disclosure” and variations thereof mean one or more embodiments, and are not intended to mean the claimed invention of any particular embodiment. Accordingly, the subject or topic of each such reference is not automatically or necessarily part of, or required by, any particular embodiment.

It is to be understood that the following disclosure provides many different embodiments, or examples, for implementing different features of various embodiments. Specific examples of components and arrangements are described below to simplify the present disclosure. These are, of course, examples and are not intended to be limiting. In addition, the present disclosure may repeat reference numerals and/or letters in the various examples. This repetition is for simplicity and clarity, and does not in itself dictate a relationship between the various embodiments and/or configurations discussed. Moreover, the formation of a first feature over or on a second feature in the description that follows may include embodiments in which the first and second features are formed in direct contact, and may also include embodiments in which additional features may be formed interposing the first and second features, such that the first and second features may not be in direct contact.

Words and terms take at least the meanings explicitly associated herein, unless the context dictates otherwise. The meanings identified below do not necessarily limit the terms, but merely provide illustrative examples for the terms. The meaning of “a”, “an”, and “the” may include plural references, and the meaning of “in” may include “in” and “on”. The phrase “in one embodiment,” as used herein does not necessarily refer to the same embodiment or another embodiment, although it may. Terms such as “providing,” “processing,” “supplying,” “determining,” “calculating” or the like may refer at least to an action of a computer system, computer program, signal processor, logic or alternative analog or digital electronic device that may be transformative of signals represented as physical quantities, whether automatically or manually initiated.

Conditional language used herein, such as, among others, “can,” “might,” “may,” “e.g.,” and the like, unless specifically stated otherwise, or otherwise understood within the context as used, is generally intended to convey that certain embodiments include certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

Values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise. The term “about” as used herein can allow for a degree of variability in a value or range, for example, within 10%, within 5%, or within 1% of a stated value or of a stated limit of a range.

The terms “a”, “an”, or “the” are used to include one or more than one unless the context clearly dictates otherwise. The term “or” is used to refer to a nonexclusive “or” unless otherwise indicated. The statement “at least one of A and B” has the same meaning as “A. B, or A and B.” In addition, it is to be understood that the phraseology or terminology employed herein, and not otherwise defined, is for the purpose of description only and not of limitation.

Any use of section headings is intended to aid reading of the document and is not to be interpreted as limiting; information that is relevant to a section heading may occur within or outside of that particular section. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference should be considered supplementary to that of this document; for irreconcilable inconsistencies, the usage in this document controls.

In any method herein, including but not limited to any methods of treatment or of manufacturing described herein, the steps can be carried out in any order without departing from the principles of the invention, except when a temporal or operational sequence is explicitly recited. Furthermore, specified steps can be carried out concurrently unless explicit claim language recites that they be carried out separately. For example, a claimed step of doing X and a claimed step of doing Y can be conducted simultaneously within a single operation, and the resulting process will fall within the literal scope of the claimed process. “Method” includes “process.”

The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more.

As used herein, the term “fluid” refers to liquids, vapors, gas, slurries, gels, and combinations or mixtures thereof, and to any mass or material that is pumpable, unless otherwise indicated.

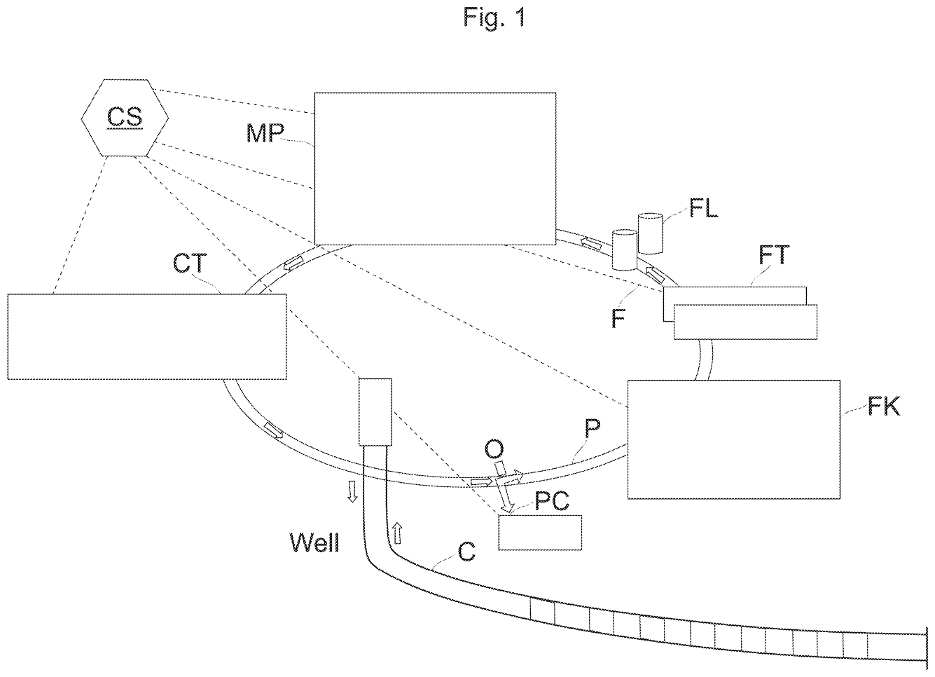

Referring now to FIG. 1, a well system according to one embodiment includes: a system CT; a mixing plant MP (also called a “blending plant”) for mixing selected chemicals, materials, and substances for introduction into a well (“Well”) via a wellhead (not shown). The well (“Well”) includes a casing C which receives the selected chemicals, materials, and substances. The system CT may be any suitable well stimulating system, including but not limited to a coiled tubing system; a treatment system FK which receives fluid from the well via piping P; a pressure control system PC for controlling fluid flow in the piping P; and a filtration system F, e.g., with any suitable fluid and/or water filtration and purification equipment or devices. For instance, the fluid and/or water filtration and purification equipment or devices may include filter(s) FL and equipment FT for providing recovered fluid to, e.g., but not limited to, the mixing plant MP or to other tanks, containers, storage, etc. The mixing plant MP is for, liner alia, mixing components of a fracturing fluid for introduction into a wellbore. The treatment system FK may, in certain aspects, be any suitable system disclosed herein according to the present invention, including, but not limited to, systems for treating flowback.

It is within the scope of the present disclosure to monitor and control each part of any system disclosed herein—including, but not limited to, any device, component, structure, machine, conduit, valve, flow path, individual item control device or apparatus, sensor, monitor, function, and equipment (“device, etc”), on site and remotely. This can be done in real time with a control system, such as control system CS in FIG. 1. The control system CS can be either on site or remote from the site, or both; and with wired and/or wireless connection to each device, etc. Control interface can be provided at an additional or alternate location, e.g., via a control interface system SE which is in communication with the control system CS. Optionally, or instead of the control interface system SE, the control system CS can be monitored and controlled via a cellphone CH at any location. In such embodiments, with the control interface system SE and/or the cellphone CH, real time information can be viewed, monitored, or retrieved for every device, etc. Optionally, alarms or alerts can be in place for various operating parameters and/or sensed data for any device, etc., and/or for any flow or material associated with or in any device, etc. A communication system such as the internet, e.g., internet I in FIG. 1, can be used to provide communication with the control system CS, the control interface system SE, and the cellphone CH. With respect to the treatment system FK, a system with, e.g., control system CS, the control interface system SE, the cellphone CH, and the internet I, can provide real time monitoring and control of all devices, machines, equipment, flows, streams, substances, gases, liquids, slurries, additives, and materials, and of all operating parameters.

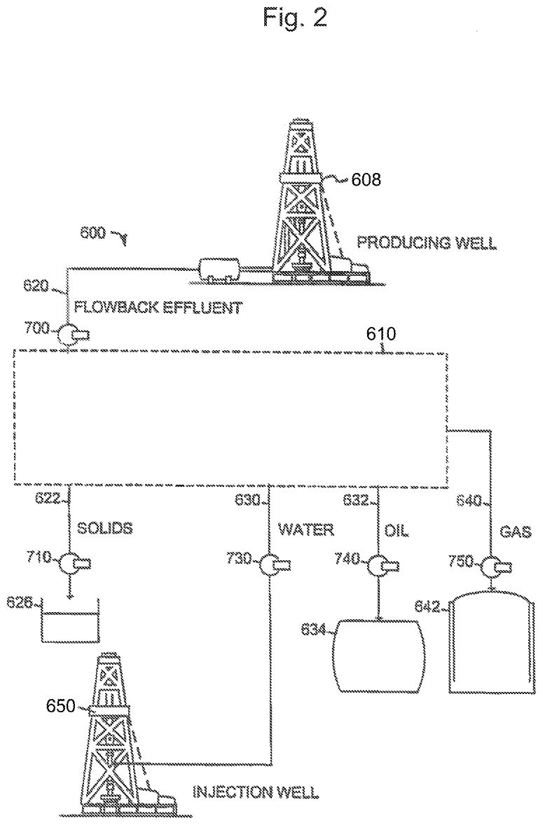

FIG. 2 illustrates an example of a flowback treatment system 600 or “separator” that accepts, treats, and separates components of a flowback stream, e.g., a multiphase flowback effluent stream into a plurality of secondary streams. As is true for any system disclosed herein, the flowback treatment system 600 may be used to treat any other suitable fluid or stream. A first sensor assembly may monitor the multiphase flowback effluent stream and generate a first signal corresponding to at least one characteristic of the multiphase flowback effluent stream. A second sensor assembly may monitor one of the plurality of secondary streams and generate a second signal corresponding to at least one characteristic of the one of the plurality of secondary streams. A signal processor may receive the signals, processes them, and determine parameters, characteristics and properties of the streams. The streams can include at least one of a solids secondary stream, an oil secondary stream, a water secondary stream, and a gas secondary stream.

The term “oil” refers to a liquid mixture that includes hydrocarbons. Oil may include residual amounts of liquid non-hydrocarbon materials and/or dissolved gases. The term “water” refers to a liquid mixture that is composed of H₂O. Water may include residual amounts of liquid hydrocarbons and/or dissolved gases. The term “gas” refers to a mixture of one or more materials in gas-phase form, with a component being a gaseous hydrocarbon such, but not limited to, methane. The term “silt” refers to solid particles of a size that the particles tend to remain in suspension during conventional separation processes. The term “fluid” refers to any substance that is capable of flowing, including particulate solids, liquids, gases, slurries, emulsions, powders, muds, glasses, mixtures, combinations thereof, and the like. The fluid may be a single phase or a multiphase fluid. In some embodiments, the fluid can be an aqueous fluid, including water or the like. In other embodiments, the fluid may be a non-aqueous fluid, including organic compounds, more specifically, hydrocarbons, oil, a refined component of oil, petrochemical products, and the like. In some embodiments, the fluid can be a treatment fluid or a formation fluid as used in the oil and gas industry. The fluid may also have one or more solids or solid particulate substances entrained therein. For instance, fluids can include various flowable mixtures of solids, liquids and/or gases. Illustrative gases that can be considered fluids according to the present embodiments, include, for example, but not limited to, air, nitrogen, carbon dioxide, argon, helium, methane, ethane, butane, and other hydrocarbon gases, combinations thereof, and/or the like.

The flowback treatment system 600 can provide real-time analysis and separation of a multiphase flowback effluent stream 620 according to certain aspects of the present disclosure. In this example, a flowback effluent stream 620 is received from a producing well 608 where, for example, a fracture stimulation process may be underway or completed. The flowback effluent stream 620 is provided, in this example, to a four-phase, closed-loop system 610 (or “separator”), wherein the “closed-loop” descriptor indicates that the liquid and gas secondary streams 630, 632, 640 are captured rather than released or, in the case of the gas secondary stream, flared off. The fluid separator 610 may be any suitable flowback treatment system according to the present disclosure. For example, the illustrated fluid separator 610 may be configured to accept as an input the flowback effluent stream 620 and provide secondary streams 622, 630, 632, and 640 of solids, water, oil, and gas, respectively. In other embodiments, however, the separator 610 (as is true for any treatment system herein according to the present disclosure) may be operated as a three-phase separator configured to separate the flowback effluent stream 620 into water, gas, and oil phases. In operation, the separator 610 may be used to separate one or more components in the flowback effluent stream from one or more other components present therein. For example, the fluid separator 610 may include any type of separator used to separate wellbore production fluids into their constituent components of, for example, oil, gas, water, precipitates, impurities, condensates (e.g., BTEX compounds), multiphase fluids, combinations thereof, and the like.

In some embodiments, various treatment chemicals, agents, or substances, as known in the art, may be added to one or more of the secondary streams to help facilitate a more efficient separation process. In certain embodiments, such treatment substances may include, for example, emulsion breakers, de-foaming agents, digester organisms, coalescing agents, and flocculants. In certain embodiments, the relative concentrations of such treatment substances can be monitored and measured using one or more of the sensor assemblies 700, 710, 730, 740, and 750 described below. As illustrated, the separator 610 includes a solids separator function, an oil/water separator function, and an oil/gas separator function, thus producing four output phases of solids, water, oil, and gas, as secondary streams. In certain embodiments, the separator 610 may further include a silt separator configured to remove fine suspended solids that may not have been removed by the initial solids separation.

A produced water secondary stream 630 may be introduced to an injection well 650 where at least a portion of the water stream 630 may be injected into a subterranean formation, for example. Various sensor assemblies 700, 710, 730, 740, and 750 may be coupled to or otherwise arranged within the secondary streams 620, 622, 630, 632, and 640, respectively. In certain embodiments, the system 600 may include a reduced number of sensor assemblies coupled to one or more of the lines for the streams 620, 622, 630, 632, and 640. In certain embodiments, each sensor assembly 700, 710, 730, 740, and 750 may include at least one composition sensor and at least one fluid properties sensor. In some embodiments, one of more of the sensor assemblies may have only one composition sensor or fluid properties sensor. In certain embodiments, each sensor assembly may be configured to detect identical characteristics of the respective effluent flows. In other embodiments, however, one or more of the sensor assemblies 700, 710, 730, 740, and 750 may be different from each other in terms of their sensing capabilities. In certain embodiments, the composition sensors of one or more of the sensor assemblies may be configured to sense one or more substances in the effluent stream from a particular source, for example the producing well 608. In certain embodiments, the oil secondary stream 632 may contain a liquid hydrocarbon that may be sold or stored at 634. In certain embodiments, the gas secondary stream 640 may contain a gaseous hydrocarbon, for example methane, that may be sold or stored at 642. One or both of the sensor assemblies 740 and 750 may determine a purity or quality of the respective oil and gas secondary streams 632, 640 and/or a quantity of oil and gas. In certain embodiments, the stream of solids 622 may be discarded or stored at 626. The present disclosure provides methods for using the system 600 and others like it according to the present disclosure.

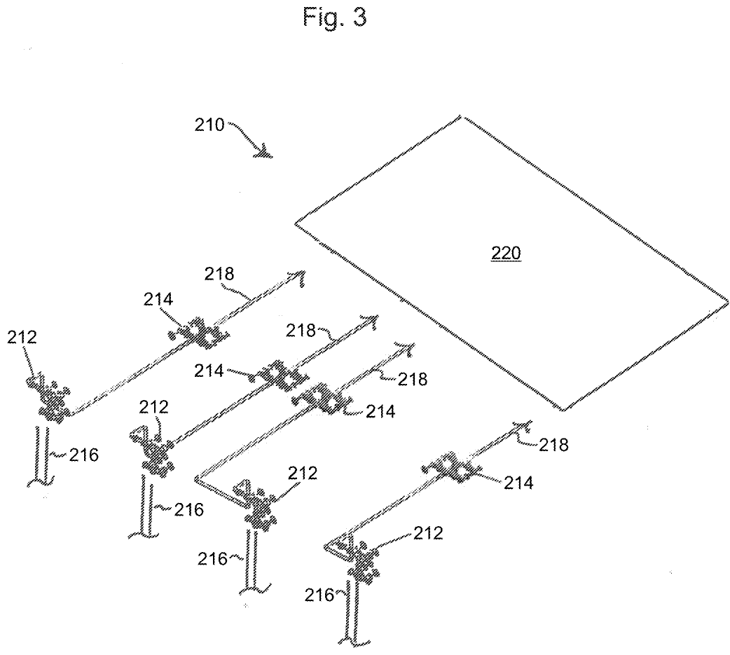

In some embodiments of the present disclosure, the systems and methods for fracturing a formation may include: fracturing the formation and then processing and treating flowback fluid from the formation from one or from a plurality of wellheads producing flowback fluid flows. Flowback fluid flows pass from the wellhead(s) to a suitable treatment system or systems according to the present disclosure. In certain embodiments, flowback fluid from a plurality of wellheads is received and processed, with each wellhead producing a flowback fluid flow. Each wellhead may be a single wellhead or one wellhead in a group of wellheads. Optionally there may be a manifold system or “skid” between the wellheads and the treatment system. The manifold can distribute the flowback fluids through a header with outlets to the treatment system according to the present disclosure. FIG. 3 shows a system 210 used for processing flowback fluid from a plurality of wellheads 212 (each in fluid communication with a corresponding well 216) according to an embodiment of the present disclosure. Flowback fluid flows from each wellhead 212 to a manifold 214 (which may be a choke manifold), and then through lines 218, through appropriate piping, valves, lines, etc. (not shown) to a treatment system 220, which may be any treatment system discussed herein. For one system 210, a group of wellheads 212 can be designated for that system 210 or all wellheads 212 at a site can be associated to the system 210. Each wellhead 212 can be connected to a choke manifold 214 which controls the flowback fluid flow.

In certain aspects, but not necessarily in all possible embodiments, the present disclosure provides systems and methods for treating contaminated water, such as, but not limited to, contaminated wastewater and fracturing fluid operations flowback water (“flowback”). The systems and methods may be used, in at least certain aspects, to treat wastewater such as hydraulic fracturing flowback water, which is contaminated with substances or materials that have been added to a fracturing fluid and is/are then present in the flowback, such as, but not limited to, viscosifiers, e.g., guar gum and similar materials, and e.g., gelling agents, or other polymers, including, but not limited to, biological polymers. The water or flowback, according to systems and methods of the present disclosure, may be heated, and in certain aspects, pressurized and heated and then, in some aspects, allowed to spend a residence time in a vessel. The process may be a continuous or a batch process. In certain embodiments, the exposure to heat, or to a combination of heat and pressure, causes the high molecular weight molecules, e.g., guar molecules or other polymer molecules, to break down into simpler substances, e.g., into simple sugars and/or other smaller, relatively low molecular weight compounds, thereby decreasing the viscosity of the fluid. Once the size of the molecules is diminished and/or viscosity is reduced, the water or flowback is then treated using any other suitable system and method disclosed herein to remove other component parts, including but not limited to, contaminants and hydrocarbons.

In certain aspects, the present disclosure provides a method of treating a stream with a plurality of components. The method may include the steps of: (a) heating the stream to produce a heated stream, (b) flowing the heated stream to a treatment system according to the present disclosure, and (c) treating the stream with the treatment system according to the present disclosure. Such a stream may be pressurized. Pressurizing may be done before the stream enters the vessel, and the pressurizing may facilitate transfer of the stream into the vessel. In such methods, the treatment system is one as disclosed herein. The methods may further include: flowing the stream to a vessel; conducting heating of the stream in the vessel; and/or pressurizing the stream in the vessel. In at least some such methods, the stream has, in certain but not necessarily all aspects: a residence time in the vessel that is not more than 10 minutes, and the stream has a viscosity, and with the stream at a temperature 25 degrees Celsius the viscosity is reduced by at least 50%. In some such methods the water is heated to about 150 to about 250 degrees Celsius and pressurized to about 200 to about 500 psi. The vessel may be a plug flow reactor or a continuous stirred tank reactor. The present disclosure provides, in at least some aspects and embodiments, a method of treating a stream with guar gum, including, but not limited to, a flowback stream with guar gum.

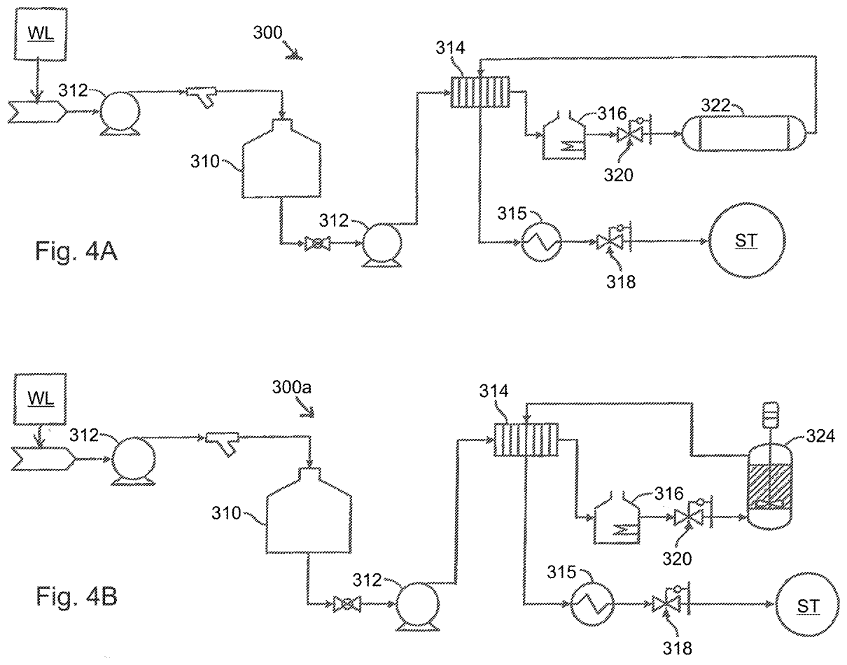

FIGS. 4A and 4B illustrate process flow diagrams of systems for treating water, e.g., contaminated wastewater or flowback, according to an embodiment. FIG. 4A shows a treatment system 300 for treating flowback from a well WL heated and/or pressurized, and then flowed to a secondary system ST. The system comprises a feed tank 310 for the untreated water; pumps 312; pressure control valves 318; temperature control valves 320; a heat exchanger 314 for preheating the wastewater; a boiler 316 for heating the wastewater to a set temperature; a plug flow reactor (PFR) 322, and an optional chiller 315 for cooling the treated wastewater. An untreated stream is pumped from the well WL through the heat exchanger 314 and the boiler 316 in order to heat the water to a desired temperature. The pressure control valve 318 comprises a sensor configured for measuring the pressure in the reactor 322 and adjusts the flow to maintain a set pressure in the plug flow reactor 322. The temperature control valve 320 may comprise a sensor configured for measuring the temperature at the boiler 316 outlet and adjusts the flow to maintain a set temperature in the plug flow reactor 322. In a preferred embodiment, the heat exchanger 314 exchanges heat between the plug flow reactor 322 outlet stream and the boiler 316 inlet stream. System parameters, including the size of the plug flow reactor 322 can be such that the residence time in the plug flow reactor 322 is sufficient to reduce the viscosity of the water stream by at least 50%. In addition, in a preferred embodiment, the plug flow reactor 322 is sized such that the residence time in the reactor 322 is sufficient to reduce the viscosity of the water stream in some particular aspects to less than about 3 centistokes at 25 degrees Celsius. FIG. 4A illustrates an exemplary embodiment utilizing a single plug flow reactor 322. In alternative embodiments, the system may utilize more than one plug flow reactor 322 configured in series or in parallel, or both, depending on the specific treatment requirements.

FIG. 4B shows a similar system 300a utilizing a continuous stirred tank reactor (CSTR) 324. As in the embodiment of FIG. 4A, the continuous stirred tank reactor 324 can be sized such that the mean residence time in the continuous stirred tank reactor 324 is sufficient to reduce the viscosity of the stream, e.g., in certain aspects by at least 50% and/or to less than about 3 centistokes at 25 degrees Celsius.

In an alternative embodiment, the system 300, 300a may be a batch system in which separate batches of water are treated. The water may be pressurized, heated, and transferred to a vessel. The batch of water may then be held in the vessel for a residence time. The temperatures, pressures, and residence times utilized in the continuous systems described above are also applicable to the batch system. In one embodiment, the water may be pressurized and heated after transferring the water to the vessel. As used herein, the term “vessel” may refer to: a tank, container, reservoir, conduit, pipe, a reactor such as a plug flow reactor or continuous stirred tank reactor, piping, or any similar type of structure or equipment suitable for heating and pressurizing a liquid solution.

Once the flowback arrives at the surface, the mixture is carried as a slurry and it is typically passed through a choke manifold and into a degasser device. The degasser device removes the gas from the slurry and allows the gas to safely vent to atmosphere or vent to a flare line. Once the gas phase of the slurry is removed, the resulting water/solids/liquid/hydrocarbon mixture is ready for separation into three distinct phases.

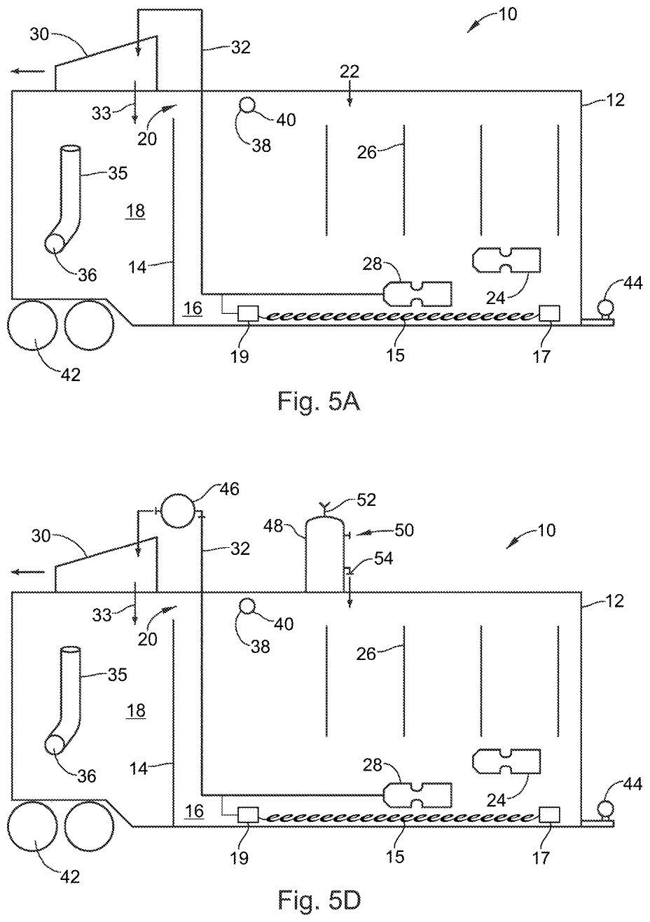

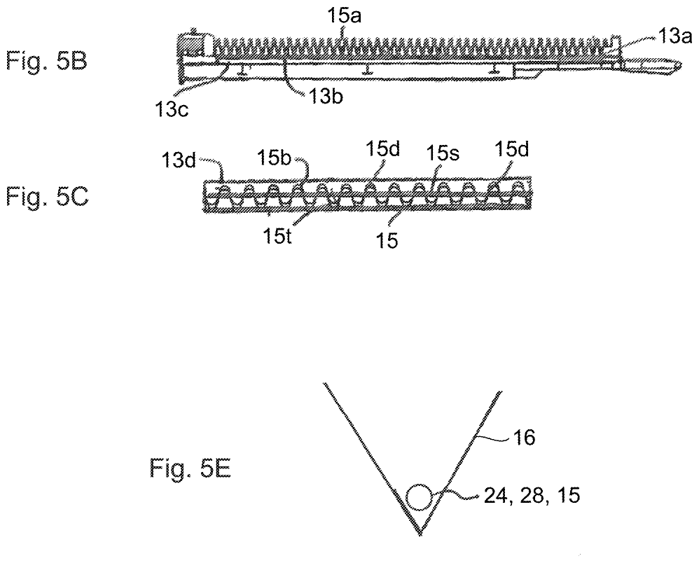

FIG. 5A depicts a system 10 according to embodiment of this disclosure. The system 10 includes a container vessel 12. Although depicted in a side view, the vessel 12 has a generally rectangular or square shape, with a top, bottom, two side walls, and two end walls. In some embodiments, the vessel 12 shape may be rectangular with a round bottom, rectangular with a flat bottom, or rectangular with a “V” shaped bottom. The vessel 12 is formed of metal and manufactured via a process well known by those skilled in the art (e.g., trailer, tank, container manufacturing). The vessel 12 is formed with a fluid-tight inner compartment. The vessel 12 may be produced using metals (e.g., stainless steel, alloys, etc.) in combination with non-metallic components (e.g., PVC, carbon fiber composites, plastics, etc.) as desired for the particular application. A vertical weir 14 in the vessel 12 divides the inner compartment into a first chamber 16 and a second chamber 18. The weir 14 forms a wall running from the floor of the vessel 12, from one side to the other, almost reaching the top of the vessel. A space 20 is left near the top of the inner compartment, allowing for fluid communication via overflow between the chambers 16, 18.

As described above, the flowback slurry is typically passed through a degasser device as it is received from the wellbore (not shown in FIG. 5A). FIG. 5A depicts the remaining solid-laden fluid mixture 22 being introduced into the first chamber 16 in the vessel 12. The solid-laden slurry 22 is conveyed to the vessel chamber 16 via conventional conduits or piping as known in the art. Embodiments of the vessel 12 may have an open or sealed top. In sealed-top embodiments, the vessel 12 may be configured with appropriate ports or hatches to allow for introduction of the fluid mixture 22. In open-top embodiments, the vessel 12 may be implemented with grating forming the top of the vessel. Once the fluid mixture 22 enters the first chamber 16, the solids and water phases of the slurry falls to the bottom area of the chamber.

The vessel 12 may include one or more tank eductors 24 mounted inside the first chamber 16, near the bottom of the chamber. Eductors (also known as jet pumps) utilize the venturi principle to cause the flow of liquid mixtures. Eductors operate on the basic principles of flow dynamics. This involves taking a high-pressure motive stream and accelerating it through a tapered nozzle to increase the velocity of the fluid (gas or liquid) that is put through the nozzle. This fluid is then carried on through a secondary chamber where the friction between the molecules of it and a secondary fluid (generally referred to as the suction fluid) causes this fluid to be pumped. These fluids are intimately mixed together and discharged from the eductor. Conventional commercial eductors can be used in implementations of the disclosed embodiments. Further description of conventional eductors may be found at the Northeast Controls Inc. website (http://www.nciweb.net/eductorl.htm).

When activated, the tank eductor(s) 24 in the first chamber 16 agitates the fluid mixture to create a turbid zone in the lower section of the chamber. The agitation caused by the tank eductor(s) 24 keeps the solids (typically sand) suspended in the fluid mixture. In some embodiments, the vessel 12 also includes one or more baffles 26 mounted inside the first chamber 16 to create a placid zone near the top of the chamber to promote collection of liquid hydrocarbons at the fluid surface. The baffle(s) 26 may be rigidly mounted in a vertical position or configured to pivot to provide angled baffling as desired. It will be appreciated by those skilled in the art that the baffle(s) 26 may be formed of any suitable material and mounted inside the chamber 16 with conventional fasteners and hardware as known in the art.

The vessel 12 incorporates one or more additional eductors 28 mounted in the first chamber 16. In operation, once the solids in the mixture 22 are suspended via activation of the tank eductor(s) 24, the additional eductor(s) 28 draws the liquid/solids mixture from the chamber for flow of the mixture to a shaker 30 to separate the solids into a distinct phase and the fluids into a disparate and distinct phase. A hose or conduit 32 is coupled to the eductor(s) 28 to convey the fluid mixture from the eductor to the shaker 30. Shakers, also known as shale shakers, are well known in the oilfield and mining industries. They provide a vibrating sieve configuration to remove solids from a solid-laden fluid mixture. One or more screens are used in the shaker to filter the fluid mixtures flowing through the shaker. The liquid phase of the mixture (generally water) passes through the screen(s) and falls below the shaker table, while solids are retained and conveyed off the device. Conventional commercial shakers can be used in implementations of the disclosed embodiments. For example, suitable shakers are manufactured by BRANDT™, in Conroe, Tex.

In some embodiments, the shaker 30 is positioned above the second chamber 18, allowing the liquids 33 separated from the fluid mixture to be gravity fed into the second chamber. The dry solids (e.g., sand) exit the shaker 30 and fall to an awaiting vessel for disposal (not shown). In other embodiments, the shaker 30 may be positioned at another location (e.g., beside the vessel 12) and the separated liquids may be conveyed to the second chamber 18 via conduit means.

Once the separated fluid in the second chamber 18 gets to a certain height, it will flow into a standpipe 35 mounted in the chamber. The standpipe 35 is coupled to a discharge port 36 formed at the side of the vessel 12. The discharge port 36 provides an outlet for the separated liquids to be conveyed to a separate storage tank or other location as desired. The discharge port 36 is configured to permit the connection of a hose or other conduit means as known in the art. The discharge port 36 is positioned on one of the vessel 12 side walls, near the lower section of the vessel to allow the separated fluids to flow from the chamber 18 via gravity feed. In some embodiments, a pump may be disposed in the second chamber 18 to flow the separated fluids under pressure.

A skimmer 38 is mounted in the first chamber 16 to collect mediums lighter than water (e.g., oil) contained in the solid-laden fluid mixture. The liquid hydrocarbon phase in the mixture has a natural proclivity to rise to the top of the chamber 16. As the liquid hydrocarbon collects it is recovered through the skimmer 38 near the top of the chamber 16. In some embodiments, the skimmer 38 consists of a slotted pipe extending across the width of the chamber 16. The lighter-than-water medium enters the slots in the skimmer 38 and is conveyed out of the vessel 12 via a skimmer port 40. The lighter-than-water liquid hydrocarbon is then transferred via a hose or conduit to be collected in an awaiting exterior tank (not shown). The lighter-than-water medium flows out of the skimmer port 40 via gravity feed as the vessel 12 processes the liquid mixtures admitted into the first chamber 16 as described herein. In some embodiments, the skimmer 38 may be configured to move up and down within the vessel 12 interior, floating near the surface of the contained liquid mixture (e.g., by forming the skimmer from appropriate materials that float). In such embodiments, the skimmer 38 may be connected to a hose coupled to the discharge port 40 and may include a pump to expel the lighter-than-water medium when the fluid level is below the port. It will be appreciated by those skilled in the art that the skimmer 38 may be configured and mounted within the vessel 12 in different ways as known in the art.

The system 10 may be used as a permanently installed unit at a desired location (indoors or outdoors). Alternatively, the system 10 may also be configured for mobile use. In some embodiments, the vessel 12 is configured with wheels for on-road transport. FIG. 1 depicts an embodiment with a pair of axles/tires 42 disposed on one end of the vessel 12. The axles/tires 42 are mounted on the vessel 12 and may be configured with brake systems via conventional techniques as known in the art. Embodiments may also be configured with lights to meet road vehicle requirements. The vessel 12 is also equipped with a conventional trailer hitch 44 at the opposite end for connection to a hauling vehicle.

The system 10 may also, in some embodiments, include an auger 15 configured via rotation to cause solids in the first chamber 16 to move out of the first chamber 16. The auger 15 may be provided with a shaft or may be a shaftless auger. The auger 15 may be located at or near the bottom of the first chamber 16, and may extend substantially the length of the first chamber 16. The auger 15 may be operatively connected to auger motor 17, which serves to rotate the auger 15 to facilitate the movement of solids that have settled to the bottom of the first chamber 16 to a pump 19, such as a hydrocyclone feed pump, which pumps the solids out of the first chamber 16. The auger motor 17 may be a pneumatic or hydraulic motor, and may be controlled by a variable frequency drive so that the speed of rotation may be varied. Thus, the operator may vary the speed of rotation of the auger 15 so that the auger 15 may vary the concentration of solids going to the pump 19. For example, the operation of auger 15 may convey a heavier concentration of solids to the hydrocyclone feed pump 19 (by decreasing rotation speed) or alternatively may convey a reduced concentration of solids to hydrocyclone feed pump 19 (by increasing rotation speed). In some embodiments, a variable frequency drive on the hydrocyclone feed pump 19 can vary the speed and/or pump pressure of the pump 19, which may vary the flow rate and/or concentration to pull more or less liquid into the hydrocyclone feed pump 19. The speed and/or pump pressure of the hydrocyclone feed pump 19 can be monitored and adjusted by adjusting the variable frequency drive. The pump pressure may be any suitable pressure, such as between approximate 5 to 40 psi. In some embodiments, the pump pressure may be initially operated at about 20 psi and may be maintained between 15-20 psi. In some cases, the speed of the auger motor 17 may be 900 rpm, or a speed higher or lower than 900 rpm. In some cases, the auger 15 may start to operate after hydrocyclone feed pump 19 is energized. The auger 15 may include a half pitch section and a full pitch section. The full pitch section may be located at rear section of the first chamber 16 at or near the intake of hydrocyclone feed pump 19. In the half pitch section, flights of the auger 15 are spaced apart in the range of about 4.5 inches to about 9 inches. In the full pitch section, flights of the auger 15 are spaced apart in the range of about 9 inches to about 18 inches. The flights may have a diameter in the range of 9 inches to 18 inches, for example 12 inch diameter. In one embodiment, the diameter of the flights may be the same as the distance between flights in the full pitch section. Solids settled in the half pitch section can exhibit an increase in the height as compared to the solids settled in the full pitch section. The reduction of solid height at the full pitch section can reduce clogging at the inlet of hydrocyclone feed pump 19. In some cases, the auger 15 may automatically begin to operate when hydrocyclone feed pump 19 is energized.

FIG. 5B shows a bottom 13a of a first chamber 13c— like the first chamber 16 of FIG. 5A—with a layer 13b with which, in operation, parts of an auger 15a are in contact. The layer 13b may be made of any suitable material which will provide the desired properties of protecting the compartment wall, reducing wear or damage to the compartment wall, reducing wear between parts and/or lubricating the contact area of parts; including, but not limited to, any suitable known material used for bushings, bearings, lubricators, wear members, wear pads, or seals; including, but not limited to, suitable thermoplastics, plastics, polymers, nylon, PTFE, PEEK, rubbers, synthetic rubbers, any suitable elastomer, hardfacing, polyurea, polyurethane, or polyethylene, or an combination thereof. The layer 13b may be in contact with the entire length of the auger or any part or parts thereof.

FIG. 5C shows an auger 15b according to an embodiment which has a central shaft 15s around which is an auger member 15d. The auger member 15d has tips 15t each with interface structure 15. The interface structures are located so that they contact an inner bottom surface of a first chamber 13d (like the first chamber of FIGS. 5A and 5B). Optionally, the inner bottom surface of the first chamber 13d may have a layer like the layer 13b, FIG. 5B. An auger like that of FIG. 5C may be used in any system herein that has an auger, including, but not limited to, that of FIG. 5A.

The interface structures 13d may be made of any suitable material which will provide the desired properties of protecting the tips 15t and/or reducing wear thereof, protecting the compartment wall, reducing wear or damage to the compartment wall, and/or lubricating the contact area of parts; including, but not limited to, any suitable known material used for bushings, bearings, lubricators, wear members, wear pads, or seals; including, but not limited to, suitable thermoplastics, plastics, polymers, nylon, PTFE, PEEK, rubbers, synthetic rubbers, nitrile rubber, neoprene, composite material, composite material with fibers therein (e.g., but not limited to, carbon fibers) any suitable elastomer, hardfacing, polyurea, urethane, polyurethane, or polyethylene, or an combination thereof. The layer 13b may be in contact with the entire length of the auger or any part or parts thereof.

FIG. 5D depicts another embodiment of a system 10. This system is similar to the embodiment of FIG. 5A, with some additional features. When activated, the eductor(s) 28 may convey the slurry mixture from the first chamber 16 to the shaker 30 at high velocity, which may hit the shaker with excessive force. A separator 46 mounted adjacent to the shaker 30 may be used to control the velocity of the fluid mixture as it is introduced into the shaker. The separator 46 may be either a cyclonic action device to remove solids from a fluid stream or a diffusion device to act as an inertial dampener prior to depositing the solid-laden fluid stream on the shaker 30 table. A conventional hydrocyclone solids-water separator may be used as known in the art. For example, suitable hydrocyclones are manufactured by WEIR™ and further description of hydrocyclone operation may be found at the following website: (https://www.global.weir/products/hydrocyclones). With a hydrocyclone separator 46, separated solids can be conveyed via a conduit for discharge along with the solids discharged from the shaker 30 and the remaining liquids can be passed through the shaker. A diffuser separator 46 may be implemented with a slotted discharge pipe configuration, a small-to-larger diameter piping system, or other structure as known in the art to dampen or slow and spread the fluid stream from the eductor 28 as it is deposited onto the shaker 30.

The embodiment of FIG. 5A is equipped with a degasser device 48 to perform the action of separating the gas phase from the mixture received from the wellbore prior to releasing the other three phases for additional processing by the system 10. The flowback mixture to be treated in the vessel 12 is transported to the degasser 48 via conventional fluid transport systems used in oilfield operations (not shown) and enters the degasser via an inlet port 50. A suitable degasser device 48 is disclosed in U.S. patent application Ser. No. 16/427,858, filed on May 31, 2019, assigned to the present assignee and incorporated herein by reference in its entirety.

The degasser 48 collects the received four-phase mixture and separates the gas vapor phase from the solids and liquids. The separated gas is discharged through a gas discharge port 52 in the degasser 48. Depending on the application and types of gases involved, the discharge port 52 may be linked via conduits to vent the gas to a flare stack for burn off or to vent the gas safely to the atmosphere. The degasser 48 includes a discharge port 54 for the remaining solids and liquids. With the degasser 48 mounted at the top of the vessel 12, the fluids and solids are discharged from the degasser and fall into the first chamber 16 via gravity feed. As the first chamber 16 fills with the solid-laden mixture, the eductors 24, 28 are activated to operate the system 10 as described herein.

The system 10 of FIG. 5D may also, in some embodiments, include an auger 15 and associated components as in the system 10 of FIG. 5A.

FIG. 5E shows that in some embodiments, the first chamber 16 may have, instead of a flat bottom or rounded bottom (in cross-section), a “V-shape”. An educator 24, 28 or the auger 15 may be provided within the “V-shape” bottom as illustrated in FIG. 5E.

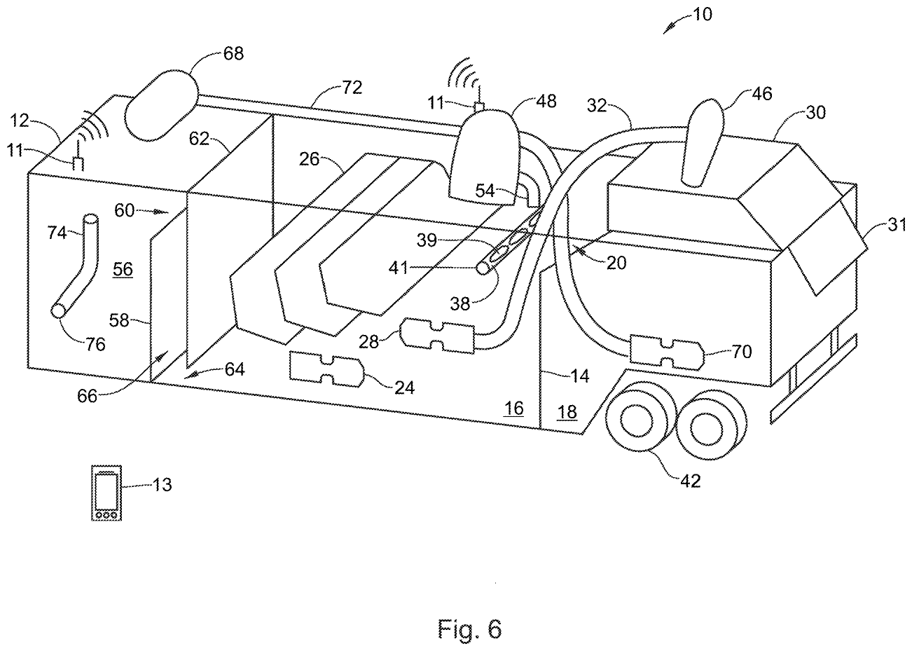

FIG. 6 depicts another embodiment of a system 10. This system is similar to the embodiments of FIG. 5A and FIG. 5D, with some additional features. The vessel 12 includes an additional chamber 56. This third chamber 56 is separated from the other chambers by a vertical weir 58 formed in the vessel 12 interior. Vertical weir 58 forms a barrier wall extending across the vessel 12 from side to side. This weir extends upward from the vessel 12 floor, leaving a gap 60 near the upper section of the chamber. Another vertical weir 62 is positioned inside the vessel 12 near weir 58, further separating the third chamber 56. Weir 62 extends downward from the top of the vessel 12, leaving a gap 64 near the vessel floor. Fluid communication is maintained between the chambers 16, 56 via a partition 66 defined by the two weirs 58, 62. Fluids from the first chamber 16 may flow into the third chamber 56 via the partition 66, but substances lighter than water (e.g., liquid hydrocarbons) in the first chamber are blocked from flow by the weir 62 extending from the top of the vessel 12.

The embodiment of FIG. 6 includes a skimmer 38 mounted in the first chamber 16 to collect mediums lighter than water (e.g., liquid hydrocarbon) contained in the solid-laden fluid mixture. As the liquid hydrocarbon collects it is recovered through the skimmer 38, which in this embodiment consists of a slotted pipe extending across the width of the first chamber 16. The lighter-than-water medium enters the slots 39 in the skimmer 38 and is conveyed out of the vessel 12 via a skimmer port 41. The lighter-than-water liquid hydrocarbon is then transferred via a hose or conduit to be collected in an awaiting exterior tank (not shown). The lighter-than-water medium flows out of the skimmer port 41 via gravity feed as the vessel 12 processes the liquid mixtures admitted into the first chamber 16 as described herein. In some embodiments, the skimmer 38 may be configured to move up and down within the vessel 12 interior, floating near the surface of the contained liquid mixture (e.g., by forming the skimmer from appropriate materials that float). In such embodiments, the skimmer 38 may be connected to a hose coupled to the discharge port 38 and may include a pump to expel the lighter-than-water medium when the fluid level is below the port. It will be appreciated by those skilled in the art that the skimmer 38 may be configured and mounted within the vessel 12 in different ways as known in the art.

The embodiment of FIG. 6 includes an additional separator 68 mounted above the third chamber 56. This separator 68 is similar to the separator 46 mounted above the second chamber 14. In this embodiment, one or more eductors 70 are mounted in the second chamber 18. The separator 68 above the third chamber 56 is coupled to the eductor(s) 70 in the second chamber 18 via hosing or tubing 72. In operation, the eductor(s) 70 sends a discharge stream of fluid and any residual solids in the second chamber 18 to the separator 68 mounted on top of the third chamber 56. Any residual solids left in the separated fluid may be removed from the discharge stream by the separator 68 and the clean fluid is gravity fed into the third chamber 56. As such, the third chamber 56 can be considered a clean effluent chamber. Removed residual solids can be conveyed via a conduit for discharge along with the solids discharged from the shaker 30. The shaker 30 includes a solids discharge tray 31 that can be extended over the edge of the vessel 12 to allow the dewatered solids to feed into an awaiting container, catch box, or conveyor to elsewhere as desired.

Once the fluid in the third chamber 56 gets to a certain height, it will flow into a standpipe 74 mounted in the chamber. The standpipe 74 is coupled to a discharge port 76 formed at the side of the vessel 12. The discharge port 76 is configured to permit the connection of a hose or other conduit means as known in the art. The solids-free fluid in the third chamber 56 is conveyed via the discharge port 76 to an additional storage tank or other location as desired.

As depicted in FIG. 6, some embodiments may also be configured with conventional electronics and computer technology including processors and antennas 11 to provide for wired or wireless control and operation of the system 10 or its individual components and subsystems. Performance and operation of the system 10 and/or its components and subsystems may be monitored and controlled using a computing device 13. System 10 embodiments may also include digital level readouts disposed on the vessel 12 and configured to wirelessly transmit data representing fluid levels in the respective vessel chambers 16, 18, 56 to the computing device 13. The computing device 13 may include, for example, a mobile phone, a tablet, a laptop computer, a desktop computer, an electronic notepad, a server computing device, etc. In some implementations, the system 10 can be implemented for remote monitoring and control via a cloud-computing architecture. In yet other embodiments, the computing device 13 may be programmed to automatically control the system 10 and/or its components and subsystems to adjust the volume of fluids processing and discharge from the vessel 12 depending on the mixture level data wirelessly received from digital level readouts. It will be appreciated by those skilled in the art that the processors may be configured to perform as described herein using conventional software using any suitable computer language and electronics protocols.

The system 10 of FIG. 6 may also, in some embodiments, include an auger 15 and associated components as in the system 10 of FIG. 5A.

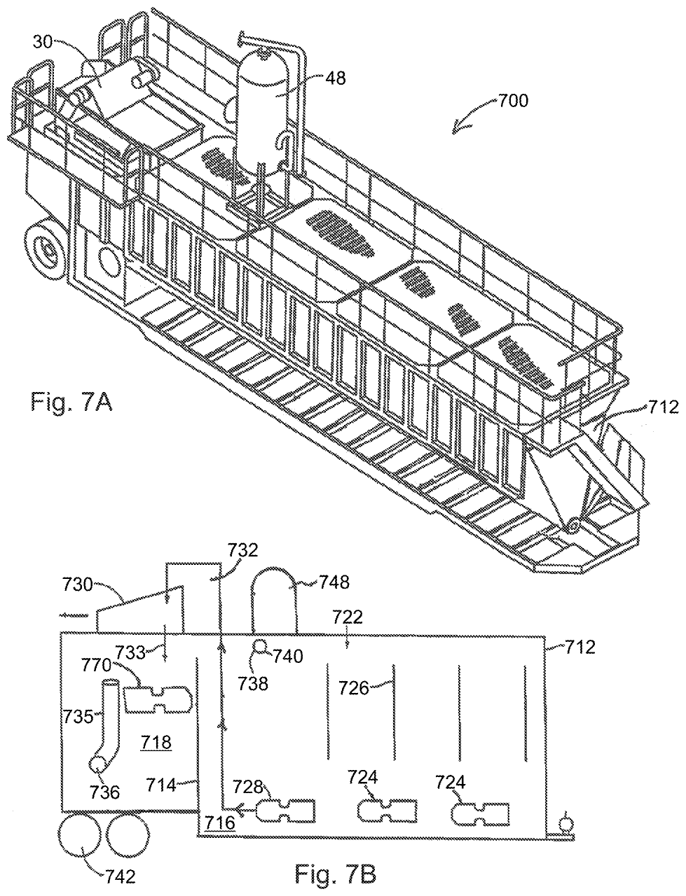

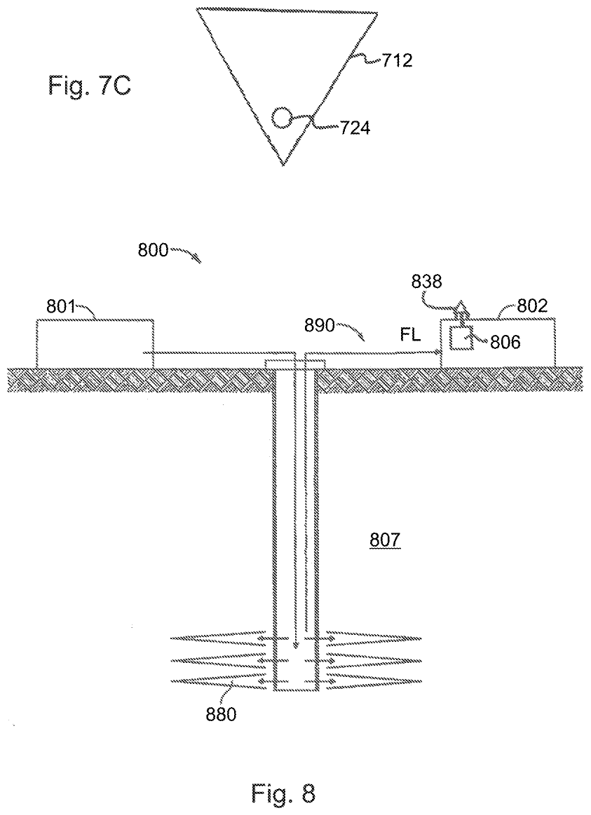

FIGS. 7A-7C show a system 700 according to an embodiment which has no auger to move material. The system 700 employs eductors 724, an eductor 728, and an eductor 770. The system 700 includes a container vessel 712. Although depicted in a side view, the vessel 712 has a generally rectangular or square shape, with a top, bottom, two side walls, and two end walls. In some embodiments, the vessel 712 shape may be rectangular with a round bottom, rectangular with a flat bottom, or rectangular with a “V” shaped bottom. The vessel 712 is formed of metal and manufactured via a process well known by those skilled in the art (e.g., trailer, tank, container manufacturing). The vessel 712 is formed with a fluid-tight inner compartment. The vessel 712 may be produced using metals (e.g., stainless steel, alloys, etc.) in combination with non-metallic components (e.g., PVC, carbon fiber composites, plastics, etc.) as desired for the particular application. A vertical weir 714 in the vessel 712 divides the inner compartment into a first chamber 716 and a second chamber 718. The weir 714 forms a wall running from the floor of the vessel 712, from one side to the other, almost reaching the top of the vessel. A space is left near the top of the inner compartment, allowing for fluid communication via overflow between the chambers 716, 718.

As described above, the flowback slurry is typically passed through a degasser device as it is received from the wellbore (not shown). FIG. 7B depicts the remaining solid-laden fluid mixture 722 being introduced into the first chamber 716 in the vessel 712. The solid-laden slurry 722 is conveyed to the vessel chamber 716 via conventional conduits or piping as known in the art. Embodiments of the vessel 712 may have an open or sealed top. In sealed-top embodiments, the vessel 712 may be configured with appropriate ports or hatches to allow for introduction of the fluid mixture 722. In open-top embodiments, the vessel 712 may be implemented with grating forming the top of the vessel. Once the fluid mixture 722 enters the first chamber 716, the solids and water phases of the slurry falls to the bottom area of the chamber.

The vessel 712 includes one or more tank eductors 724 (in system 700 there are two) mounted inside the first chamber 716, near the bottom of the chamber. Eductors utilize the venturi principle to cause the flow of liquid mixtures. Eductors operate on the basic principles of flow dynamics. This involves taking a high-pressure motive stream and accelerating it through a tapered nozzle to increase the velocity of the fluid (gas or liquid) that is put through the nozzle. This fluid is then carried on through a secondary chamber where the friction between the molecules of it and a secondary fluid (generally referred to as the suction fluid) causes this fluid to be pumped. These fluids are intimately mixed together and discharged from the eductor.

When activated, the tank eductor(s) 724 in the first chamber 716 agitates the fluid mixture to create a turbid zone in the lower section of the chamber. The agitation caused by the tank eductor(s) 724 keeps the solids (typically sand) suspended in the fluid mixture. In some embodiments, the vessel 712 also includes one or more baffles 726 mounted inside the first chamber 716 to create a placid zone near the top of the chamber to promote collection of liquid hydrocarbons at the fluid surface. The baffle(s) 726 may be rigidly mounted in a vertical position or configured to pivot to provide angled baffling as desired. It will be appreciated by those skilled in the art that the baffle(s) 726 may be formed of any suitable material and mounted inside the chamber 716 with conventional fasteners and hardware as known in the art.

The vessel 712 incorporates an additional eductor 728 mounted in the first chamber 716. In operation, once the solids in the mixture 722 are suspended via activation of the tank eductor(s) 724, the additional eductor(s) 728 draws the liquid/solids mixture from the chamber for flow of the mixture to a shaker 730 to separate the solids into a distinct phase and the fluids into a disparate and distinct phase. A hose or conduit 732 is coupled to the eductor(s) 728 to convey the fluid mixture from the eductor to the shaker 730. One or more screens are used in the shaker to filter the fluid mixtures flowing through the shaker. The liquid phase of the mixture (generally water) passes through the screen(s) and falls below the shaker table, while solids are retained and conveyed off the device.

In some embodiments, the shaker 730 is positioned above the second chamber 718, allowing the liquids 733 separated from the fluid mixture to be gravity fed into the second chamber. The dry solids (e.g., sand) exit the shaker 730 and fall to an awaiting vessel for disposal (not shown). In other embodiments, the shaker 730 may be positioned at another location (e.g., beside the vessel 712) and the separated liquids may be conveyed to the second chamber 718 via conduit means.

Once the separated fluid in the second chamber 718 gets to a certain height, it will flow into a standpipe 735 mounted in the chamber. The standpipe 735 is coupled to a discharge port 736 formed at the side of the vessel 712. The discharge port 736 provides an outlet for the separated liquids to be conveyed to a separate storage tank or other location as desired. The discharge port 736 is configured to permit the connection of a hose or other conduit means as known in the art. The discharge port 736 is positioned on one of the vessel 712 side walls, near the lower section of the vessel to allow the separated fluids to flow from the chamber 718 via gravity feed. In some embodiments, a pump may be disposed in the second chamber 718 to flow the separated fluids under pressure.

A skimmer 738 is mounted in the first chamber 716 to collect mediums lighter than water (e.g., oil) contained in the solid-laden fluid mixture. The liquid hydrocarbon phase in the mixture has a natural proclivity to rise to the top of the chamber 716. As the liquid hydrocarbon collects it is recovered through the skimmer 738 near the top of the chamber 716. In some embodiments, the skimmer 738 consists of a slotted pipe extending across the width of the chamber 716. The lighter-than-water medium enters the slots in the skimmer 738 and is conveyed out of the vessel 712 via a skimmer port 740. The lighter-than-water liquid hydrocarbon is then transferred via a hose or conduit to be collected in an awaiting exterior tank (not shown). The lighter-than-water medium flows out of the skimmer port 740 via gravity feed as the vessel 712 processes the liquid mixtures admitted into the first chamber 716 as described herein. In some embodiments, the skimmer 738 may be configured to move up and down within the vessel 712 interior, floating near the surface of the contained liquid mixture (e.g., by forming the skimmer from appropriate materials that float). In such embodiments, the skimmer 738 may be connected to a hose coupled to the discharge port 740 and may include a pump to expel the lighter-than-water medium when the fluid level is below the port. It will be appreciated by those skilled in the art that the skimmer 738 may be configured and mounted within the vessel 712 in different ways as known in the art.

The system 710 may be used as a permanently installed unit at a desired location (indoors or outdoors). Alternatively, the system 710 may also be configured for mobile use. In some embodiments, the vessel 712 is configured with wheels for on-road transport, with a pair of axles/tires 742 disposed on one end of the vessel 712. The axles/tires 742 are mounted on the vessel 712 and may be configured with brake systems via conventional techniques as known in the art. Embodiments may also be configured with lights to meet road vehicle requirements. The vessel 712 is also equipped with a conventional trailer hitch at the opposite end for connection to a hauling vehicle.

Optionally, a degasser device 748 to perform the action of separating the gas phase from the mixture received from the wellbore prior to releasing the other three phases for additional processing by the system 710. The flowback mixture to be treated in the vessel 712 is transported to the degasser 748 via conventional fluid transport systems used in oilfield operations (not shown) and enters the degasser via an inlet port 50.

The degasser 748 collects the received four-phase mixture and separates the gas vapor phase from the solids and liquids. The separated gas is discharged through a gas discharge port in the degasser 748. Depending on the application and types of gases involved, the discharge port may be linked via conduits to vent the gas to a flare stack for burn off or to vent the gas safely to the atmosphere. The degasser 748 includes a discharge port for the remaining solids and liquids. With the degasser 748 mounted at the top of the vessel 712, the fluids and solids are discharged from the degasser and fall into the first chamber 716 via gravity feed. As the first chamber 716 fills with the solid-laden mixture, the eductors 724, 728 are activated to operate the system as described herein.

The eductor 770 conveys underflow from the shaker 730 to the chamber 716.

FIG. 8 depicts a diagrammatic view of a fracturing system 800 according to an embodiment that includes, among other items and features, a fracturing fluid injection system and a flowback treatment system including an operations section, a recovery function, and structures, devices, machines, piping, valves, tanks, controls, sensors, and equipment for treatment of flowback. The flowback treatment system may be any flowback treatment system according to the present disclosure, including, but not limited to, those particular embodiments shown in the drawing figures and those described in the text of this document.

Certain embodiments disclosed herein may provide for a method of performing a separation process, where the method may include the steps of transporting a single-trailer, single-transport, or single-skid separation unit to a worksite; performing downhole operations at the worksite; recovering a fluid stream into the separation unit, wherein the stream may result from performing the downhole operations, e.g., but not limited to an earth fracturing operation; and using the separation unit to separate the stream into at least one of an aqueous phase, an organics phase, a solids phase, and a gas phase; or into any three of such components or into all such four components. Any and each such system may include, according to the present disclosure, a signal capture and data acquisition system operatively connected with the operations section, wherein the signal capture and data acquisition system is configured to provide monitoring and autonomous operation of the system and each part, structure, function, and/or section thereof, and wherein the signal capture and data acquisition system is interfaced from a location on the separation unit, a location at the worksite, a remote location, or combinations thereof. In certain aspects and features, but not necessarily all, the signal capture and data acquisition system comprises an internet interface. Optionally, the internet interface further comprises sensors to determine pressure, flow rate, fluid parameters, flow parameters, and fluid levels in real time and a viewer, and wherein the viewer displays real-time system data for each parameter or monitored item, e.g., but not limited to, comprising pressure, temperature, flow rate, and fluid levels.

In certain of these systems, system comprises pumps to pressurize and reinject a separated stream, e.g., but not limited to a stream with water, into a wellbore and into a formation, and methods for suing such systems can include pressurizing and/or reinjecting the stream into the subterranean formation. In certain embodiments of such systems and methods usable to separate various constituents of fluids produced from a formation, the systems include versatile, all-in-one units usable to receive or extract energy from a producing formation, such as, but not limited to, flowback from a fracturing recovery process. The unit (e.g., with any treatment system according to the present disclosure) may be provided with monitoring (e.g., on-site and/or remote monitoring) and control capabilities to evaluate real time process performance, and in various embodiments, to enable unmanned (i.e. personnel not present at the unit or not present at the worksite) operation of the system.

Referring to FIG. 8, a fracturing operation according to the present embodiment with the system 800 involves injection of a high-pressure fracturing fluid from a source 801 into a formation 807, such that the fracturing fluid initiates and propagates a fracture 880 in the formation that increases formation permeability and improves the flow path for formation fluids. Optionally, sand or highly permeable proppant materials entrained in the fracturing fluid maintain the fracture, e.g., “propping” the fracture open, so that an increase in recovery of hydrocarbons may be achieved. Proppant materials can include, for example, sand, ceramic beads, glass beads, etc. In a single well fracturing process, thousands or even hundreds of thousands of pounds of proppant material can be used, as well several million gallons of water, or more. Accordingly, a step of a fracturing process according to the present disclosure can include the recovery of the injected fluids, which occurs by flowing or lifting the well (e.g., energy recovery), also referred to as “flowback” FL. When the flowback recovery process 890 begins, at least a portion of the injected fracturing fluid or flowback FL is produced from the formation 807 and processed by the flowback treatment system 802. The flowback stream generally contains an oil/water mixture, along with a variety of other contaminants carried therein. The contaminants may include, for example, hydrocarbons, gelling additives, as well as other contaminants, including debris, drilled cuttings, rock, organometals and the like, in addition to proppant materials.

Raw materials consumed during fracturing processes, such as water, are extremely valuable resources that must often be conserved where possible due to various laws or regulations. For example, water used to make fracturing fluid may be available from local streams and ponds, or purchased from a municipal water utility; however, the use of such water can be extremely expensive due to the permits required. Alternatively, in certain aspects and embodiments tanker trucks can be used to transport water and/or proppant materials to a well site. In certain embodiments, fracturing operations include treatment, separation, and recycling of flowback fluid. Certain systems and methods include the use of storage containers (tanks, vessels, reservoirs) to store flowback materials, and the use of tanker trucks to transport the stored materials away from a well site for further processing, disposal or treatment. For a single well, these practices can require 300 tanker trucks, or more, to carry more than two million gallons of flowback materials for offsite disposal.

The system 802, according to certain embodiments of the present disclosure may have a number of interacting operable sections, such as, for example, the operations section 806, which can be used to control and/or monitor the system 802. Other optional devices and equipment usable with system 802 may include, for example, one or more high pressure and/or high volume pumps (e.g., powerful triplex, or quintiplex pumps) and/or a monitoring unit. Any of the equipment may be configured or designed to operate over a wide range of pressures and injection rates, and may exceed pressure ratings of 15,000 psi and working capacities of 100 barrels per minute. The system may be coupled with an external source (e.g, a producing subterranean formation, a wellhead, etc.), such that the source can provide a feed stream to the system 802. In an embodiment, the feed stream may be a flowback fluid stream recovered from a formation upon completion of a fracturing process. The system 802 can include a signal capture and data acquisition (SCADA) system 838, or a similar monitoring and/or control system operatively connected therewith, which may thus be used in conjunction with the overall operation of the system 802. The SCADA system 838 may include any manner of industrial control systems or other computer control systems that monitor and control operation of the system 802, on-site, remotely, or both. In one embodiment, the SCADA system 838 may be configured to provide monitoring and autonomous operation of the system 802. The SCADA system 838 may be interfaced from any location, such as from an interface terminal (not shown). In an embodiment, the SCADA system 838 can be interfaced and/or controlled from the operations section 806. Additionally or alternatively, the SCADA system 838 may be interfaced remotely, such as via an interim connection that is external to the on-site unit. A usable Internet interface may include a viewer or other comparable display device, whereby the viewer may display real-time system parameters and performance data.

The operations of the system 802 may utilize a number of indicators, alarms, alerts, and/or sensors, such as sight glasses, liquid floats, temperature gauges or thermocouples, pressure transducers, etc. In addition, the system 802 may include various meters, recorders, and other monitoring devices. These devices may be utilized to measure and record data, such as the quantity and/or quality of the organic phase(s), the liquid phase(s), and the vapor or gas produced by the system 802. The SCADA system 838 may provide an operator or control system with real-time information regarding the performance of the system 802. It should be understood that any components, sensors, etc. of the SCADA system 838 may be interconnected with any other components or subcomponents of the system 802. As such, the SCADA system 838 can enable on-site and/or remote control of the system 802, and in an embodiment, the system 802 can be configured to operate without on-site and/or remote human intervention, such as through automatic actuation of the system components responsive to certain measurements and/or conditions and/or use of passive emergency systems. The system 838 may be configured with devices to measure “HI” and/or “LOW” pressure or gas flow rates. The use of such information may be useful as an indication of whether use of a compressor in conjunction with a flare operation is necessary, or as an indication for determining whether the gas flow rate to the flare should to be increased or decreased. The system 838 may also be coupled with fire, pressure, and liquid level alarms and/or safety shutdown devices, which may be accessible from remote locations, such as a wellhead or wellheads.

The SCADA system 838 may include a number of subsystems, such as a human-machine interface (HMI). The HMI may be used to provide process data to an operator, and as such, the operator may be able to interact with, monitor, and control the system 802. In addition, the SCADA system 838 may include a master or supervisory computer system configured to gather and acquire system data, and to send and receive control instructions, independent of human interaction. A remote terminal may also be operably connected with various sensors. In an embodiment, the terminal may be used to convert sensor data to digital data, and then transmit the digital data to the computer system. As such, there may be a communication connection between the supervisory system to the terminals. Programmable logic controllers may also be used. Data acquisition of the system 802 may be initiated at the terminal and/or PLC level, and may include, for example, meter readings, equipment status reports, etc., which may be communicated to the SCADA 838 as required. The acquired data may then be compiled and formatted in such a way that an operator using the HMI may be able to make command decisions to effectively run the system 802 at great efficiency and optimization. For example, all operations of the system 802 may be monitored in a control room within or associated with the operations section 806.

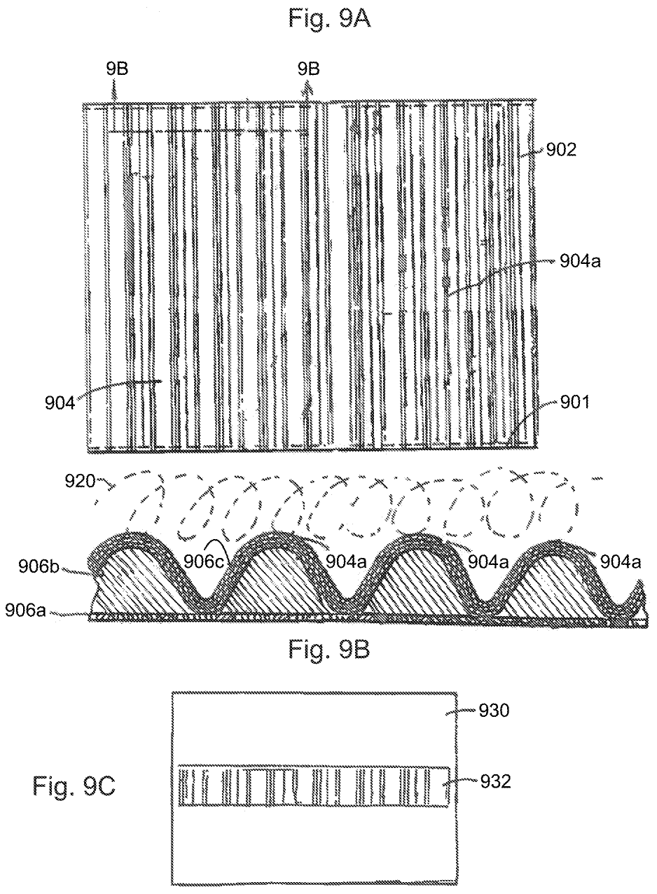

It is within the scope of the present disclosure to provide a bottom surface for a tank or container that is non-flat or has a portion that is non-flat for contacting an auger that, in operation, contacts the surface. FIG. 9A shows a portion 902 of a bottom 901 of a tank that has an undulating surface 904. An auger 920—shown in dotted lines in FIG. 9B which can be a shafted or a shaftless auger—moves with parts thereof in contact with ridge tops 904a of the surface 904. In operation, the auger 920 cannot touch portions of the surface 904 below the ridge tops 904a. Thus the auger cannot wear or damage the lower portions of the surface. It is within the scope of the present disclosure for the bottom of the tank to be an integral member; or, as shown in FIG. 9B, the bottom can comprise a bottom member 906a with a top member 906b. Optionally, the top member 906b can have a layer 906c thereon or formed integrally thereof. Optionally, the layer 906c reduces or eliminates wear or damage to the bottom 902. In certain aspects, the layer 906c is metal or it is made from any suitable known material used for bushings, bearings, lubricators, wear members, wear pads, or seals; including, but not limited to, suitable thermoplastics, plastics, polymers, nylon, PTFE, PEEK, rubbers, nitrile rubber, neoprene, urethane, composite material, composite material with fibers therein, synthetic rubbers, any suitable elastomer, hardfacing, polyurea, polyurethane, or polyethylene, or any combination thereof.

It is within the scope of the present disclosure to treat only that part of a bottom of a tank that will be contacted by an auger; or to provide only a portion like the undulating surface shown in FIG. 9B. FIG. 9C shows a bottom 930 of a tank with a portion 932 that is undulating with ridge tops and lower portions like the surface shown in FIG. 9B. An auger can be positioned above and in alignment with the portion 932. The portion 932 can extend for the entire surface of a tank, as shown, or, alternatively only parts of the bottom can be undulating (in which case some of the auger may touch some of the bottom surface; or there may be sufficient ridge tops or raised portions to maintain all of the auger out of contact with the bottom).

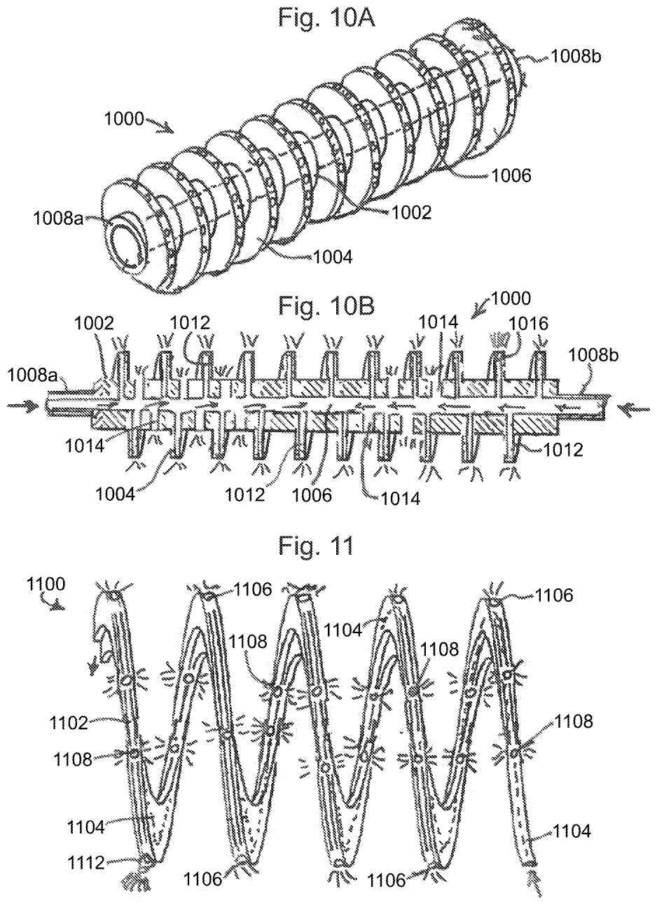

It is within the scope of the present disclosure to provide: augers, shafted or shaftless, from which fluid, e.g., water or a fluid with water, is expelled; systems with such an auger and methods using such a system; water treatment systems with such an auger and methods using such a system; flowback treatment systems with such an auger and methods using such a system; salt water or brine treatment systems with such an auger and methods using such a system; and such augers with structure for expelling fluid from a spiral or helix of an auger and/or, when present, from a shaft of a shafted auger. The present disclosure provides augers with structure for expelling fluid: along the entire length of an auger; at only a certain point or area of an auger; along the entire shaft of an auger which has a shaft; at only part of a shaft or from only one area of a shaft; and/or from inner parts of an auger's spiral or helix, at outer tips or areas of an auger's spiral or helix, or both. The augers discussed above and those shown in FIGS. 10A. 10B and 11 can have such structure or structures.

FIGS. 10A and 10B show an auger 1000 according to an embodiment with a central shaft 1002 and an auger helix 1004. The shaft 1002 has a fluid flow channel 1006 therethrough from one end 1008a to another end 1008b. The shaft may be closed to flow at one end or, as shown, open to flow at each end. Fluid, e.g., but not limited to, water, contaminated water, salt water, brine, produced water, wastewater, or flowback, may be pumped into one or both ends 1008a, 1008b. The channel 1006 is in fluid communication with flow channels 1012 in the helix 1004 and with flow channels 1014 in the shaft. The channels 1012 have fluid exit ends at an outer surface of the helix. Channels 1014 have fluid exit ends at an outer surface of the shaft 1002. Either the channels 1012 or the channels 1014 can be deleted. Fluid flows under pressure from the channel 1006 to the channels 1012 and to the channels 1014. Fluid expelled from the auger can: facilitate the auger's movement of fluids, slurries, and/or solids; provide mixing action for materials adjacent to the auger; inhibit clogging of the auger; and/or can facilitate the breaking of emulsions. As shown in FIG. 10B, a channel 1012 has a nozzle 1016 through which fluid is expelled from the auger 1000. Any suitable nozzle may be used. Any channel of the auger 1000 (and any such flow channel of any auger herein) may have such a nozzle. Such a nozzle can: provide focused flow of fluid from the auger; jetted flow of fluid from the auger; increased pressure flow of fluid from the auger; desired-direction flow of fluid from the auger (e.g., but not limited to, in a direction toward solids in a tank and/or solid below an auger; and in close proximity to an auger.

FIG. 11 shows a shaftless auger 1100 according to an embodiment which has a spiral member 1102 with a fluid flow channel 1104 therethrough through which fluid may be pumped under pressure. Fluid is expelled from the auger 1100 through openings 1106 at edges of the auger 1100 and through openings 1108 along a body of the auger 1100. Any and all openings may have a nozzle 1112 (one shown) and such a nozzle or nozzles may be on the auger or within the auger in fluid communication with the flow channel 1104.

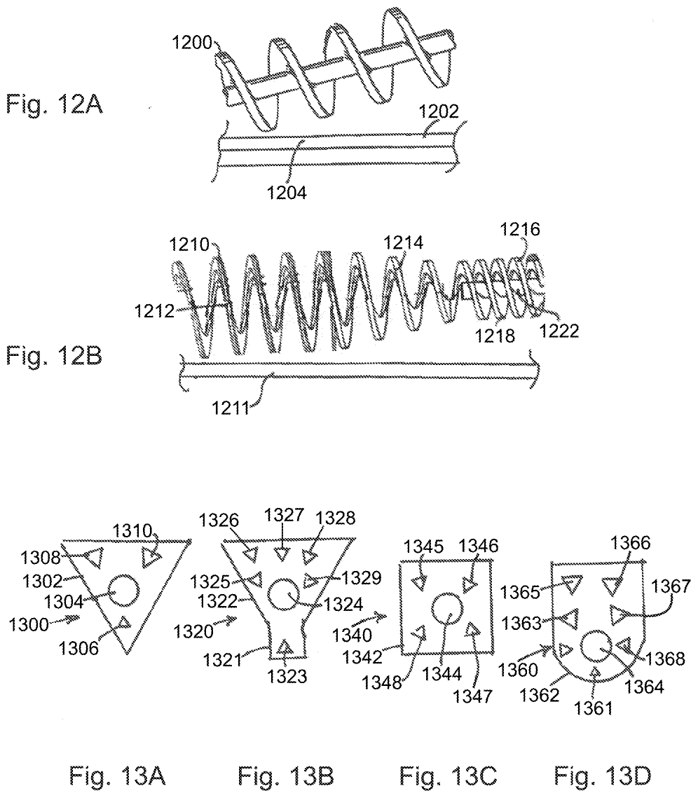

The present disclosure provides tanks and systems with tanks in which an auger is not mounted level, parallel to a tank bottom, or horizontally with respect to a bottom surface or to a top surface of a tank. An auger may, according to the present disclosure, be inclined from the horizontal. Such an auger may have only a portion of the auger in contact with a tank surface or none of the auger may be in contact with the tank surface. For example, and not by way of limitation, an auger in a shaftless auger system as in FIG. 5A may have only a portion in contact with a tank bottom with part of the auger elevated so it does not contact the tank bottom. FIG. 12A shows a system according to an embodiment with a shafted auger 1200 (shown partially) according to the embodiment mounted in a tank with bottom 1202 (shown partially). Optionally the bottom 1202 has a layer 1204, e.g., but not limited to, like the layers described above, e.g., but not limited to, the layers 13c, FIG. 5B and 906b, FIG. 9B. The auger 1200 is mounted at an angle to the tank bottom 1202. The auger 1202 may be mounted so that part of it contacts the bottom 1202 or, as shown, it may be mounted so that none of it contacts the bottom 1202. FIG. 12B shows a system according to an embodiment with a tank with a bottom 1211 (shown partially) an auger 1210 according to the embodiment which has a portion 1212 which is shaftless, a portion 1214 which is shaftless, and a portion 1216 with a spiral portion 1218 mounted on a shaft 1222. The auger 1210 is mounted at an angle to the tank bottom 1211. The auger 1210 may be mounted so that part of it contacts the bottom 1211 or, as shown, it may be mounted so that none of it contacts the bottom 1211.

It is within the scope of the present disclosure to mount an auger above a tank bottom so that no part of the auger touches any surface of the tank. It is within the scope of the present disclosure to use one or more eductors around or adjacent an auger to, inter cilia, facilitate operation of the auger and/or the movement of material and/or solids by the auger. FIG. 13A shows a system 1300 according to the present disclosure for processing fluid with a tank 1302 and an auger 1304 mounted in the tank 1302 for moving fluid with solids from one part of the tank to another. The tank is a “V tank” as shown in cross-section in FIG. 13A. Optionally eductors 1306, 1308, and 1310 are used with the auger 1304. Such eductors may, inter cilia, be used as the eductors described above, e.g., and not limited to, as eductors shown in FIGS. 5A, 5D, 6, and 7B. The auger 1304 is not in contact with surfaces of the tank.

FIG. 13B shows a system 1320 according to the present disclosure for processing fluid with a tank 1322 and an auger 1324 mounted in the tank 1322 for moving fluid with solids from one part of the tank to another. The tank is a “V tank” as shown in cross-section in FIG. 13B with a squared-off bottom 1321. Optionally eductors 1323, 1325, 1326, 1327, 1328 and 1329 are used with the auger 1324. Such eductors may, inter alia, be used as the eductors described above, e.g., and not limited to, as eductors shown in FIGS. 5A, 5D, 6, and 7B. The auger 1324 is not in contact with surfaces of the tank.

FIG. 13C shows a system 1340 according to the present disclosure for processing fluid with a tank 1342 and an auger 1344 mounted in the tank 1342 for moving fluid with solids from one part of the tank to another. The tank 1342 has a general rectangular cross-section as shown in cross-section in FIG. 13C. Optionally eductors 1345, 1346, 1346, 1347, and 1348 are used with the auger 1344. Such eductors may, inter alia, be used as the eductors described above, e.g., and not limited to, as eductors shown in FIGS. 5A, 5D, 6, and 7B. The auger 1344 is not in contact with surfaces of the tank.

FIG. 13D shows a system 1360 according to the present disclosure for processing fluid with a tank 1362 and an auger 1364 mounted in the tank 1362 for moving fluid with solids from one part of the tank to another. The tank 1362 has a general rectangular cross-section with a rounded bottom as shown in cross-section in FIG. 13D. Optionally eductors 1361, 1363, 1365, 1366, 1367, and 1368 are used with the auger 1364. Such eductors may, inter alia, be used as the eductors described above, e.g., and not limited to, as eductors shown in FIGS. 5A, 5D, 6, and 7B. The auger 1364 is not in contact with surfaces of the tank.

Augers such as those disclosed above and as shown in FIGS. 10A, 10B. 11, and 13A-13D may, inter alia, be used in any of the systems disclosed herein.

The present disclosure, is some aspects and embodiments, provides systems and methods for treating oil sand to separate its components and to remove components from it. “Oily sand” and “oily sands,” for purposes of this disclosure, includes: oil contaminated sand (contaminated accidentally, negligently, or intentionally), oil sands, tar sands, crude bitumen, and bituminous sands. Oil sands, tar sands, crude bitumen, and bituminous sands are unconventional petroleum deposits. Oily sand includes sand contaminated with oil from an oil spill or from the intentional contamination of sand with oil. Oily sand can have any particular oil content, and in some, but not all cases, can be 3% to 6% oil by weight. Some sand intentionally contaminated in Kuwait has an oil content of about 7% and up to 10% or more. Oily sand can be present in the form of an oily liquid, a sludge, a slurry, or an emulsion. Oily sand can be either loose sands or partially consolidated sandstone containing a naturally occurring mixture of sand, clay, and water, soaked with a type of oil called bitumen, a dense and extremely viscous form of petroleum that can be too heavy or thick to flow on its own.

Oil and construction-grade sand can be recovered from oily sand using systems and methods according to the present disclosure. Oil sand processed with systems according to the present disclosure can provide stabilizing material for other projects such as road building, as a surfacing material, as backfill, and for other engineering and construction applications. For treating oily sands, systems according to the present disclosure can be used onsite, in situ, near situ, or a location remote from the initial location of the oily sands. Systems according to the present disclosure can treat oily sands in individual batches or in a continuous-flow mode. Systems according to the present disclosure can, among other things, separate entrained hydrocarbons from an oily sand in the form of an emulsion. In any such system, according to the present disclosure eductor(s) in the system may have nozzle structure formed integrally thereof or a nozzle can be connected to an eductor body so that passing an oily sand therethrough cleanses the oily sand. (Any eductor in any system herein can have such a nozzle structure or nozzle), separating hydrocarbon from the sand. Thus separated hydrocarbon, due to its density relative to water, will float upward, e.g., to or at a top layer of liquid in a tank of the system, and can, therefore, be evacuated from the tank and/or captured by oil skimmer(s). Solids broken free of the emulsion can fall to the bottom of the tank and can then flow through eductor(s) for separation from water over shaker(s).

Optionally, heat can be applied to an input of oily sand to the system and/or to separated constituent material of oily sand. Heat applied at appropriate temperatures can reduce the viscosity of contaminating materials, e.g., but not limited to, paraffins and asphaltenes, thereby further breaking an oily sand emulsion and enhancing the separation of components of the oily sand. It is within the scope of the present disclosure to chemically treat oily sand to be input to a system according to the present disclosure and, inter alia, to break oily sand emulsions before they enter a tank of a system and/or within the tank.

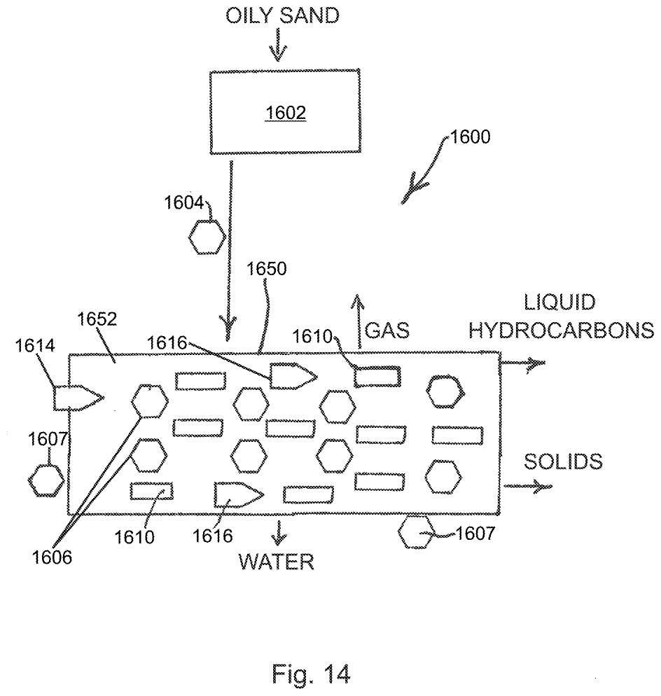

FIG. 14 shows a system 1600 according to an embodiment in which oily sand is introduced into tank 1652 of a system 1650. The system 1650 may be any system according to the present disclosure described herein, shown in any of the drawing figures, and/or in any of the paragraphs or any of the claims below. Optionally, the oily sand is pretreated in a pretreatment system 1602. The pretreatment system 1602 may be any suitable known system for treating oily sand, particularly oil sands, to produce a fluid stream for introduction into the system 1650 for facilitating treatment of the oily sand by the system 1650. In various, but not necessarily all, aspects, the pretreatment system 1602 can chemically treat the oily sand, mechanically treat it (e.g., with desasnders, centrifuges, hydrocyclones, etc.), and/or heat it. Optionally a stream of oily sand (including an input stream or a stream exiting the system 1602) is heated with a heater 1604. Oily sand in the tank 1602 may be chemically treated using a chemical treatment system 1614 and this can include treating the oily sand with additives added into the tank 1602 with the chemical treatment system 1614.

Similar chemical treatment systems 1616 may be used within the tank 1602. A heater or heaters 1606 can be used within the tank 1602 as desired at any point or location to heat any area, any material, or any stream. A heater or heaters 1607 entirely or partially outside the tank 1602 can be used as desired at any point or location to heat any area, any material, or any stream. Optionally, it is within the scope of this disclosure to use shale shaker(s) which heat input to the shakers and/or heat output liquid or solids. It is within the scope of this disclosure to provide such systems with any eductor or eductors shown in any drawing herein or disclosed in any description herein, at any location shown or described, to facilitate the flow of any oily sand, to cleanse solids, to break a hydrocarbon from a solid, to enhance the treatment thereof, and/or to enhance the separation of a component or components of the oily sand. For example, and not by way of limitation, this includes eductors 1610.

The present invention provides, by way of example and not by way of limitation, the subject matter, inter alia, disclosed in the Paragraphs A-Z below.
A. A system for treating fluid, the fluid including liquid and material, the system including a tank and an eductor or eductors in the tank, the eductor(s) providing one, two, three, or all of these functions: moving the fluid within or out of the tank; mixing the fluid and material; and/or cleaning the material, to include, but not limited to, facilitating the separation of liquid from the material. In certain aspects, the fluid is flowback and the material is solids in the flowback. In certain aspects, the fluid is oily sand. In certain aspects, the fluid is produced water. In certain aspects, the fluid is slat water or brine. In certain aspects, the fluid is drilling fluid with drilled cuttings. In certain aspects, the fluid is drill out fluid with solids. In certain aspects, the fluid is a well fluid with cement.
B. A system as in A that is any system in any of FIGS. 1-14.
C. A system, any system, as in A or as in B with or without an auger or augers in the tank, the auger or augers being shafted augers or shaftless augers.
D. A method for treating fluid, the method including using a system as in A, a system as in B, or a system as in C.
E. A system for fracturing an earth formation.
F. Any new method herein for fracturing an earth formation.
G. A flowback treatment system according to the present invention which uses an eductor or eductors in a container (e.g., a tank), the container for receiving and containing the flowback, the flowback containing liquid and solids, the eductor(s) for moving the flowback with the solids, the system producing streams of gas, liquid hydrocarbons, water, and solids, the eductor(s) also for moving the solids stream originating from flowback, including, but not limited to moving a solids stream from a shaker or shakers of the system; such a system including, but not limited to, any system in any of FIGS. 1-14 with an eductor or with a plurality of eductors.
H. Any system herein that comprises a transportable system with a plurality of axles and corresponding wheels and/or tires, including, but not limited to, a system with two front axles and/or a system with two rear axles.
I. A system for treating fluid comprising a first subsystem for separating components of a fluid, e.g., but not limited to a fluid comprising a flowback stream from an earth formation, the system including a second subsystem comprising a control system, the first subsystem having a plurality of components, the control system providing communication with the first subsystem and both on-site and remote control of the components of the first subsystem, the control system including apparatus for monitoring operation of the components of the first subsystem and for communicating with the first subsystem and with its components; the control system, in some aspects and embodiments, comprising a system as the system CS, FIG. 1 or a system 806 with associated system 838, FIG. 8. Such a system can include apparatus for the control system to communicate with and via the internet.
J. A treatment system according to the present invention, including, but not limited to, a flowback treatment system, with: a container, the container for receiving and containing fluid (the fluid with liquid and solids), e.g., flowback, the flowback containing liquid and solids; an auger within the container for moving solids; the container having a bottom surface; the auger having parts with an auger surface, the auger surface contacting the bottom surface in operation of the system; the bottom surface and/or the auger surface including material and/or structure to facilitate movement of the auger, movement of the solids, and/or to reduce or inhibit wear of and/or damage to the auger and/or to the bottom surface by the auger.
K. A flowback treatment system according to the present invention with: a container, the container for receiving and containing flowback; an auger within the container for moving solids in the flowback; the container having a bottom surface; the auger having parts that contact the bottom surface in operation of the system; the parts including material therein and/or thereon to facilitate movement of the auger, movement of the solids, and/or to reduce or inhibit wear of and/or damage to the bottom surface by the auger.
L. A flowback treatment system according to the present invention with: a container, the container for receiving and containing flowback; a shaftless auger within the container for moving solids; the container having a bottom surface; the shaftless auger having parts with an auger surface, the auger surface contacting the bottom surface in operation of the system; the bottom surface and/or the auger surface including material and/or structure to facilitate movement of the auger, movement of the solids, and/or to reduce or inhibit wear of and/or damage to the auger and/or to the bottom surface by the auger.
M. A flowback treatment system according to the present invention with: a container, the container for receiving and containing flowback; a shaftless auger within the container for moving solids; the container having a bottom surface; the shaftless auger having parts that contact the bottom surface in operation of the system; the parts including material therein and/or thereon to facilitate movement of the auger, movement of the solids, and/or to reduce or inhibit wear of and/or damage to the bottom surface by the auger.
N. A fluid treatment system, including any herein according to the present invention and any other system that uses an auger or augers for moving material, the fluid treatment system or any other system including an eductor or eductors in a container, the container for receiving and containing fluid, the auger or augers for moving solids in the container and therefrom, the fluid treatment system or other system including but not limited to any system in any of FIGS. 1-8 with an eductor or with a plurality of eductors, the eductor or eductors including one or a plurality of eductors for facilitating solids movement by the auger or augers and/or for reducing clogging of an auger or augers and/or for reducing wear of a portion or portions of an auger or augers, and/or for reducing wear of a part of the container contacted by a part of an auger or augers.
O. A system for fracturing an earth formation, the system having a mixing apparatus for preparing a fluid for fracturing the earth formation, introduction apparatus for introducing the fluid under pressure through a well adjacent the earth formation and into the earth formation, flow apparatus for receiving flowback from the earth formation from the well and providing the flowback to a treatment system, the treatment system for separating components of the flowback, the treatment system comprising any suitable treatment system according to the present invention including but not limited to any system shown in any of FIGS. 1-14 and/or described in the text herein. In certain aspects, the introduction apparatus is for introducing fluid to a plurality of wells and the treatment system receives flowback from each well of the plurality of wells. In certain aspects, the treatment system includes an auger in a tank, the auger for moving solids from flowback within the tank and for moving solids from the tank; and, optionally, the auger and/or the tank have material therein or thereon for inhibiting wear of the tank and/or wear of the auger. In any such system, there can be no eductor in the tank; or at least one eductor, one eductor, or a plurality of eductors in the tank to facilitate operation of the auger and/or to facilitate movement of solids in the tank and/or to facilitate the separation of solids from liquid, and/or to facilitate exhaust of solids from the tank.
P. An auger, with or without a shaft, for moving material from a fluid, e.g., but not limited to flowback, the material in a tank, the auger having material therein or thereon for inhibiting wear of the tank by the auger and/or wear of the auger from contact with the tank. In certain aspects, such an auger has an auger member, and the auger member has a length, the auger member having a portion that is shaftless and a portion with a shaft.
Q. Any and every new system disclosed herein and/or claimed for treating salt water or brines.
R. Any and every new method disclosed herein and/or claimed for treating salt water or brines.
S. Any and every new system disclosed herein and/or claimed for treating oily sand.
T. Any and every new method disclosed herein and/or claimed for treating oily sand.
U. Any and every new system disclosed herein and/or claimed for treating drill out fluids.
V. Any and every new method disclosed herein and/or claimed for treating drill out fluids.
W. Any and every new system disclosed herein and/or claimed for treating fluid with drill cuttings.
X. Any and every new method disclosed herein and/or claimed for treating fluid with drill cuttings.
Y. Any and every new system disclosed herein and/or claimed herein using an eductor or eductors, the system further comprising employing action of the eductor(s) to separate hydrocarbons from solids containing the hydrocarbons and/or to separate hydrocarbons from a fluid containing the hydrocarbons.
Z. Any and every new method disclosed herein and/or claimed herein using an eductor or eductors, the method further comprising using the eductor(s) to separate hydrocarbons from solids containing the hydrocarbons and/or to separate hydrocarbons from a fluid containing the hydrocarbons.

Advantages of the disclosed embodiments include a closed-loop fluids processing system, a smaller footprint eliminating the number of additional tanks required, reduced rental and transportation costs, a reduced need for additional logistical support equipment, providing fast and simple rig ups and rig downs and mobilizations, lower transportation and fluid disposal costs, conformity with environmental regulations, minimal operator decisions and errors, and eliminating the possibility of downstream fluid contamination.

In light of the principles and example embodiments described and depicted herein, it will be recognized that the example embodiments can be modified in arrangement and detail without departing from such principles. Also, the foregoing discussion has focused on particular embodiments, but other configurations are also contemplated. Even though expressions such as “in one embodiment,” “in another embodiment,” or the like are used herein, these phrases are meant to generally reference embodiment possibilities, and are not intended to limit the invention to particular embodiment configurations. As used herein, these terms may reference the same or different embodiments that are combinable into other embodiments. As a rule, any embodiment referenced herein is freely combinable with any one or more of the other embodiments referenced herein, and any number of features of different embodiments are combinable with one another, unless indicated otherwise. The terms “including” and “comprising” are used in an open-ended fashion, and thus should be interpreted to mean “including, but not limited to. . . . ”

In view of the wide variety of useful permutations that may be readily derived from the example embodiments described herein, this detailed description is intended to be illustrative only, and should not be taken as limiting the scope of the invention. What is claimed as the invention, therefore, are all implementations that come within the scope of the following claims, and all equivalents to such implementations.

What is claimed is:

1. A system for separating solids from a fluid mixture, comprising:
a vessel including a first chamber to receive a solid-laden fluid mixture, and a second chamber to receive liquids separated from the solid-laden fluid mixture;
at least one eductor disposed in the first chamber to flow the solid-laden fluid mixture out of the first chamber; and
an auger disposed in the first chamber to move at least solids of the solid-laden fluid mixture out of the first chamber.

2. The system of claim 1, further comprising a shaker configured to receive the solid-laden fluid mixture from the first chamber and separate liquids from the solid-laden fluid mixture for return of the separated liquids to the second chamber.

3. The system of claim 2, further comprising a separator configured to receive the solid-laden fluid mixture prior to passage of the solid-laden fluid mixture to the shaker.

4. The system of claim 1, further comprising a degasser to remove gases from the solid-laden fluid mixture prior to passage of the solid-laden fluid mixture to the first chamber.

5. The system of claim 1, wherein the auger is disposed adjacent an inner surface of the vessel, the inner surface comprises an undulated profile including valleys and ridges, and the auger does not contact the valleys of the undulated profile.

6. The system of claim 5, wherein the inner surface comprises a material for reducing or eliminating wear from the auger on the inner surface.

7. The system of claim 1, wherein the auger comprises at least one internal fluid flow channel and at least one nozzle in communication with the fluid flow channel, wherein the at least one nozzle is configured to expel a fluid in the at least one internal fluid flow channel from the auger.

8. The system of claim 1, further comprising at least one heater to heat the solid-laden fluid mixture.

9. The system of claim 1, further comprising at least one chemical treatment device to chemically treat the solid-laden fluid mixture.

10. A system for separating solids from a fluid mixture, comprising:
a vessel including a first chamber to receive a solid-laden fluid mixture, and a second chamber to receive liquids separated from the solid-laden fluid mixture; and
an auger disposed in the first chamber to move at least solids of the solid-laden fluid mixture out of the first chamber, wherein
the auger is disposed adjacent an inner surface of the vessel, the inner surface comprises an undulated profile including valleys and ridges, and the auger does not contact the valleys of the undulated profile.

11. The system of claim 10, wherein the inner surface comprising the undulated profile comprises a material for reducing or eliminating wear from the auger on the inner surface.

12. The system of claim 10, wherein the auger comprises at least one internal fluid flow channel and at least one nozzle in communication with the fluid flow channel, wherein the at least one nozzle is configured to expel a fluid in the at least one internal fluid flow channel from the auger.

13. A method for separating solids from a fluid mixture, comprising:
admitting a solid-laden fluid mixture into a first chamber of a vessel;
receiving at a second chamber liquids separated from the solid-laden fluid mixture;
flowing the solid-laden fluid mixture out of the first chamber via at least one educator provided in the first chamber; and
moving at least solids of the solid-laden fluid mixture out of the first chamber via an auger provided in the first chamber.

14. The method of claim 13, further comprising receiving the solid-laden fluid mixture from the first chamber and separating, via a shaker, the liquids from the solid-laden fluid mixture for return of the separated liquids to the second chamber.

15. The method of claim 14, further comprising separating solids from the solid-laden fluid mixture prior to passage of the solid-laden fluid mixture to the shaker.

16. The method of claim 14, further comprising removing gases from the solid-laden fluid mixture prior to passage of the solid-laden fluid mixture to the first chamber.

17. The method of claim 14, further comprising heating the solid-laden fluid mixture.

18. The method of claim 14, further comprising chemically treating the solid-laden fluid mixture.

19. The method of claim 14, further comprising flowing fluid through at least one internal fluid flow channel inside the auger, and expelling the fluid through at least one nozzle in the auger.

20. The method of claim 14, further comprising rotating the auger adjacent an inner surface of the vessel, wherein the inner surface comprises an undulated profile including valleys and ridges, and the auger does not contact the valleys of the undulated profile during the rotating.
